(19) United States
(12) Patent Application Publication
(10) Pub. No.: US 2025/0393093 A1
(43) Pub. Date: Dec. 25, 2025

(54) UNIFIED TRANSMISSION CONFIGURATION INDICATION STATE FOR TIME INTERVALS ASSOCIATED WITH DIFFERENT DUPLEX TYPES

(71) Applicant: QUALCOMM Incorporated, San Diego, CA (US)

(72) Inventors: Qian ZHANG, Basking Ridge, NJ (US); Yan ZHOU, San Diego, CA (US); Muhammad Sayed Khairy ABDELGHAFFAR, San Jose, CA (US)

(21) Appl. No.: 18/747,829

(22) Filed: Jun. 19, 2024

(51) Int. Cl. H04W 76/20; H04L 5/00; H04L 5/14; H04W 72/231

(52) U.S. Cl. CPC H04W 76/20; H04L 5/0051; H04L 5/14; H04W 72/231

(57) ABSTRACT

Various aspects of the present disclosure generally relate to techniques to configure and indicate separate transmission configuration indication (TCI) states under a unified TCI framework for sub-band full-duplex (SBFD) and non-SBFD intervals. Some aspects more specifically relate to configuring a unified TCI state type for each duplex type, and to configuring and indicating uplink and downlink TCI states for SBFD and non-SBFD intervals. For example, one or more TCI state pools may define candidate TCI states for SBFD and non-SBFD intervals, and various techniques may be used to indicate specific unified TCI states to be used in SBFD and non-SBFD intervals. In this way, a user equipment (UE) may be configured to communicate using different uplink and downlink beams in SBFD and non-SBFD intervals, and/or uplink power control may be configured separately for SBFD and non-SBFD intervals.

### FIELD OF THE DISCLOSURE

Aspects of the present disclosure generally relate to wireless communication and specifically relate to techniques, apparatuses, and methods associated with a unified transmission configuration indication state for time intervals associated with different duplex types.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

In some examples, a wireless network may support full-duplex communication, which generally includes simultaneous bi-directional communication between devices in the wireless network. For example, a network node operating in a full-duplex mode may receive an uplink communication and transmit a downlink communication at the same time (for example, in the same slot or the same symbol). For example, a network node and/or a user equipment (UE) may support a sub-band full-duplex (SBFD) communication mode. In the SBFD mode, a network node may receive an uplink communication from a first UE in an uplink sub-band and may simultaneously transmit a downlink communication to a second UE in a downlink sub-band (for example, where simultaneous reception and transmission occurs in different frequency resources). For example, the uplink sub-band and the downlink sub-band may be different sub-bands within a frequency band or a component carrier, such as a time division duplexing (TDD) band. In this case, frequency resources used for downlink communication may be separated from frequency resources used for uplink communication, in the frequency domain, by one or more guard bands. In this way, the SBFD mode may result in increased throughput by allowing simultaneous uplink and downlink communication, reduced latency by allowing uplink and/or downlink communication to occur earlier in time, and/or increased spectral efficiency by simultaneously utilizing downlink and uplink resources.

As described herein, SBFD operation may be a capability that is supported by a network node only, a UE only, or both a network node and a UE. Furthermore, network nodes and UEs may generally support a legacy half-duplex communication mode, where a network node only transmits a downlink communication to a UE or only receives an uplink communication from the UE in any particular transmission time interval (TTI). Accordingly, in some examples, a duplexing mode or duplexing configuration can be semi-statically or dynamically switched or otherwise configured in different TTIs, such as different symbols or slots (for example, depending on one or more conditions, such as self-interference at a network node or a UE that supports SBFD operation, an uplink and/or downlink traffic demand, and/or an uplink and/or downlink traffic periodicity, among other examples). For example, in any particular TTI, communication may be configured in a legacy half-duplexing mode (for example, where a network node and a UE communicate using half-duplexing), a network node SBFD mode (for example, where a network node operating in SBFD mode simultaneously communicates on a downlink with a first UE and on an uplink with a second UE), a network node and UE SBFD mode (for example, where a network node and a UE both operate in an SBFD mode), or a UE SBFD mode (for example, where a UE operating in SBFD mode simultaneously communicates on a downlink with a first transmission reception point (TRP) and on an uplink with a second TRP).

However, enabling SBFD and non-SBFD operation in different TTIs poses challenges because a wireless channel may be subject to different conditions in SBFD symbols and non-SBFD symbols. For example, SBFD operation may depend on spatial separation between uplink and downlink beams to mitigate self-interference, whereas a common beam may be used for uplink and downlink communication in non-SBFD symbols. In another example, an uplink and downlink beam pair that best minimizes interference may vary in SBFD and non-SBFD symbols. Furthermore, separate uplink power control may be appropriate for uplink transmissions in SBFD and non-SBFD symbols (for example, an uplink transmit power may be reduced in SBFD symbols to mitigate self-interference or cross-link interference).

### SUMMARY

Some aspects described herein relate to a method of wireless communication performed at a user equipment (UE). The method may include receiving, from a network node, information that configures a unified transmission configuration indication (TCI) state type for one or more duplex types. The method may include receiving, from the network node, information that indicates one or more TCI states for communicating one or more of uplink channels, downlink channels, or reference signals in intervals associated with the one or more duplex types. The method may include communicating, with the network node in an interval associated with a duplex type, of the one or more duplex types, in accordance with the unified TCI state type and the one or more TCI states configured for the duplex type associated with the interval.

Some aspects described herein relate to a method of wireless communication performed at a network node. The method may include transmitting, to a UE, information that configures a unified TCI state type for one or more duplex types. The method may include transmitting, to the UE, information that indicates one or more TCI states for communicating one or more of uplink channels, downlink channels, or reference signals in intervals associated with the one or more duplex types. The method may include communicating, with the UE in an interval associated with a duplex type, of the one or more duplex types, in accordance with the unified TCI state type and the one or more TCI states configured for the duplex type associated with the interval.

Some aspects described herein relate to an apparatus for wireless communication at a UE. The apparatus may include one or more memories storing processor-executable code and one or more processors coupled with the one or more memories. At least one processor of the one or more processors may be configured to cause the apparatus to receive, from a network node, information that configures a unified TCI state type for one or more duplex types. At least one processor of the one or more processors may be configured to cause the apparatus to receive, from the network node, information that indicates one or more TCI states for communicating one or more of uplink channels, downlink channels, or reference signals in intervals associated with the one or more duplex types. At least one processor of the one or more processors may be configured to cause the apparatus to communicate, with the network node in an interval associated with a duplex type, of the one or more duplex types, in accordance with the unified TCI state type and the one or more TCI states configured for the duplex type associated with the interval.

Some aspects described herein relate to an apparatus for wireless communication at a network node. The apparatus may include one or more memories storing processor-executable code and one or more processors coupled with the one or more memories. At least one processor of the one or more processors may be configured to cause the apparatus to transmit, to a UE, information that configures a unified TCI state type for one or more duplex types. At least one processor of the one or more processors may be configured to cause the apparatus to transmit, to the UE, information that indicates one or more TCI states for communicating one or more of uplink channels, downlink channels, or reference signals in intervals associated with the one or more duplex types. At least one processor of the one or more processors may be configured to cause the apparatus to communicate, with the UE in an interval associated with a duplex type, of the one or more duplex types, in accordance with the unified TCI state type and the one or more TCI states configured for the duplex type associated with the interval.

Some aspects described herein relate to a non-transitory computer-readable medium that stores a set of instructions for wireless communication by a UE. The set of instructions, when executed by one or more processors of the UE, may cause the UE to receive, from a network node, information that configures a unified TCI state type for one or more duplex types. The set of instructions, when executed by one or more processors of the UE, may cause the UE to receive, from the network node, information that indicates one or more TCI states for communicating one or more of uplink channels, downlink channels, or reference signals in intervals associated with the one or more duplex types. The set of instructions, when executed by one or more processors of the UE, may cause the UE to communicate, with the network node in an interval associated with a duplex type, of the one or more duplex types, in accordance with the unified TCI state type and the one or more TCI states configured for the duplex type associated with the interval.

Some aspects described herein relate to a non-transitory computer-readable medium that stores a set of instructions for wireless communication by a network node. The set of instructions, when executed by one or more processors of the network node, may cause the network node to transmit, to a UE, information that configures a unified TCI state type for one or more duplex types. The set of instructions, when executed by one or more processors of the network node, may cause the network node to transmit, to the UE, information that indicates one or more TCI states for communicating one or more of uplink channels, downlink channels, or reference signals in intervals associated with the one or more duplex types. The set of instructions, when executed by one or more processors of the network node, may cause the network node to communicate, with the UE in an interval associated with a duplex type, of the one or more duplex types, in accordance with the unified TCI state type and the one or more TCI states configured for the duplex type associated with the interval.

Some aspects described herein relate to an apparatus for wireless communication. The apparatus may include means for receiving, from a network node, information that configures a unified TCI state type for one or more duplex types. The apparatus may include means for receiving, from the network node, information that indicates one or more TCI states for communicating one or more of uplink channels, downlink channels, or reference signals in intervals associated with the one or more duplex types. The apparatus may include means for communicating, with the network node in an interval associated with a duplex type, of the one or more duplex types, in accordance with the unified TCI state type and the one or more TCI states configured for the duplex type associated with the interval.

Some aspects described herein relate to an apparatus for wireless communication. The apparatus may include means for transmitting, to a UE, information that configures a unified TCI state type for one or more duplex types. The apparatus may include means for transmitting, to the UE, information that indicates one or more TCI states for communicating one or more of uplink channels, downlink channels, or reference signals in intervals associated with the one or more duplex types. The apparatus may include means for communicating, with the UE in an interval associated with a duplex type, of the one or more duplex types, in accordance with the unified TCI state type and the one or more TCI states configured for the duplex type associated with the interval.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network.

FIG. 2 is a diagram illustrating an example network node in communication with a user equipment (UE) in a wireless network.

FIG. 3 is a diagram illustrating examples of full-duplex communication.

FIG. 4 is a diagram illustrating examples of full-duplex deployments.

FIG. 5A is a diagram illustrating examples of different duplexing modes.

FIG. 5B is a diagram illustrating an example of sub-band full-duplex (SBFD) activation.

FIG. 6 is a diagram illustrating an example of using beams for access link communications.

FIG. 7 is a diagram illustrating an example of a transmission configuration indication (TCI) state indication in a unified TCI framework.

FIGS. 8A-8E are diagrams illustrating examples of a unified TCI state for time intervals associated with different duplex types.

FIG. 9 is a flowchart illustrating an example process performed, for example, by a UE.

FIG. 10 is a flowchart illustrating an example process performed, for example, by a network node.

FIGS. 11-12 are diagrams of example apparatuses for wireless communication.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

As described herein, sub-band full-duplex (SBFD) operation may be a capability that is supported by a network node only, a user equipment (UE) only, or both a network node and a UE. Furthermore, network nodes and UEs may generally support a legacy half-duplex communication mode, where a network node only transmits a downlink communication to a UE or only receives an uplink communication from the UE in any particular transmission time interval (TTI). Accordingly, in some examples, a duplexing mode or duplexing configuration can be semi-statically or dynamically switched or otherwise configured in different TTIs, such as different symbols or slots (for example, depending on one or more conditions, such as self-interference at a network node or a UE that supports SBFD operation, an uplink and/or downlink traffic demand, and/or an uplink and/or downlink traffic periodicity, among other examples). For example, in any particular TTI, communication may be configured in a legacy half-duplexing mode (for example, where a network node and a UE communicate using half-duplexing), a network node SBFD mode (for example, where a network node operating in SBFD mode simultaneously communicates on a downlink with a first UE and on an uplink with a second UE), a network node and UE SBFD mode (for example, where a network node and a UE both operate in an SBFD mode), or a UE SBFD mode (for example, where a UE operating in SBFD mode simultaneously communicates on a downlink with a first transmission reception point (TRP) and on an uplink with a second TRP).

However, enabling SBFD and non-SBFD operation in different TTIs poses challenges because a wireless channel may be subject to different conditions in SBFD symbols and non-SBFD symbols. For example, SBFD operation may depend on spatial separation between uplink and downlink beams to mitigate self-interference, whereas a common beam may be used for uplink and downlink communication in non-SBFD symbols. In another example, an uplink and downlink beam pair that best minimizes interference may vary in SBFD and non-SBFD symbols. Furthermore, separate uplink power control may be appropriate for uplink transmissions in SBFD and non-SBFD symbols (for example, an uplink transmit power may be reduced in SBFD symbols to mitigate self-interference or cross-link interference).

Various aspects relate generally to techniques to configure and indicate separate transmission configuration indication (TCI) states under a unified TCI framework for SBFD and non-SBFD symbols. Some aspects more specifically relate to configuring a unified TCI state type (for example, a joint uplink and downlink TCI state, or separate uplink and downlink TCI states) for each duplex type. Furthermore, some aspects relate to configuring and indicating uplink and downlink TCI states for SBFD and non-SBFD symbols. For example, in some aspects, a radio resource control (RRC) configuration may indicate one or more TCI state pools that define candidate TCI states for SBFD and non-SBFD symbols, and various techniques may be used to indicate unified TCI states to be used for uplink communication and downlink communication in SBFD and non-SBFD symbols in different slots. For example, the unified TCI states to be used for uplink communication and downlink communication in SBFD and non-SBFD symbols may be configured in one or more RRC messages, or one or more medium access control (MAC) control elements (MAC-CEs) can be used to activate one or more TCI codepoints that are each associated with one or two TCI states for SBFD or non-SBFD operation. For example, separate MAC-CEs may activate TCI codepoints for SBFD or non-SBFD operation, or a single MAC-CE may activate TCI codepoints for SBFD and non-SBFD operation with each TCI codepoint being associated with a duplex type field indicating whether the TCI codepoint is activated for SBFD or non-SBFD symbols. In some aspects, a MAC-CE may activate a TCI codepoint mapped to up to four TCI states, including up to two TCI states for SBFD symbols and up to two TCI states for non-SBFD symbols. If multiple TCI codepoints and/or TCI states are activated for SBFD and/or non-SBFD symbols, one or more downlink control information (DCI) messages may be used to indicate one TCI codepoint for SBFD symbols, one TCI codepoint for non-SBFD symbols, and/or one TCI codepoint for SBFD and non-SBFD symbols.

Particular aspects of the subject matter described in this disclosure can be implemented to realize one or more of the following potential advantages. In some examples, by configuring and indicating separate unified TCI states for SBFD and non-SBFD symbols, a UE may be configured to communicate using different uplink and downlink beams in SBFD and non-SBFD symbols. Furthermore, by configuring a UE to communicate using different uplink and downlink beams in SBFD and non-SBFD symbols, uplink and downlink beam pairs can be selected to mitigate dynamic interference conditions (such as self-interference or cross-link interference), increase resource utilization and/or spectrum efficiency, and/or dynamically configure uplink and downlink resources to improve performance in SBFD symbols. In addition, uplink and downlink beam pairs may be configured for non-SBFD symbols to optimize performance according to conditions that are specific to non-SBFD symbols. Furthermore, by configuring and indicating separate unified TCI states for SBFD and non-SBFD symbols, different uplink power control parameters may be configured for SBFD and non-SBFD symbols according to the specific conditions in each symbol type.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

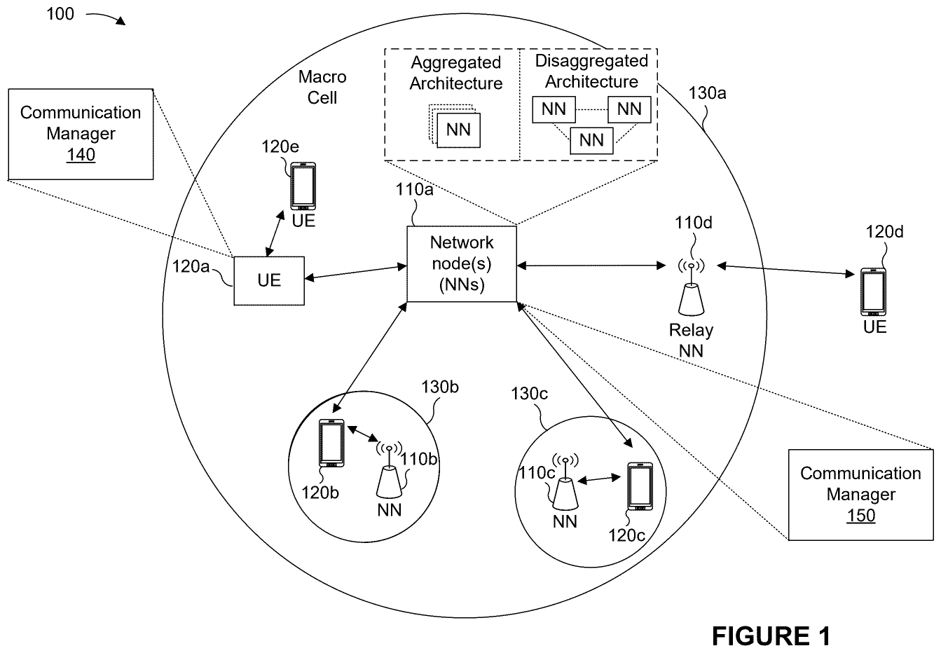

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHz), FR3 (7.125 GHz through 24.25 GHz), FR4a or FR4-1 (52.6 GHz through 71 GHz), FR4 (52.6 GHZ through 114.25 GHz), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a MAC layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication.

In some aspects, the UE 120 may include a communication manager 140. As described in more detail elsewhere herein, the communication manager 140 may receive, from a network node, information that configures a unified TCI state type for one or more duplex types; receive, from the network node, information that indicates one or more TCI states for communicating one or more of uplink channels, downlink channels, or reference signals in intervals associated with the one or more duplex types; and communicate, with the network node in an interval associated with a duplex type, of the one or more duplex types, in accordance with the unified TCI state type and the one or more TCI states configured for the duplex type associated with the interval. Additionally or alternatively, the communication manager 140 may perform one or more other operations described herein.

In some aspects, the network node 110 may include a communication manager 150. As described in more detail elsewhere herein, the communication manager 150 may transmit, to a UE, information that configures a unified TCI state type for one or more duplex types; transmit, to the UE, information that indicates one or more TCI states for communicating one or more of uplink channels, downlink channels, or reference signals in intervals associated with the one or more duplex types; and communicate, with the UE in an interval associated with a duplex type, of the one or more duplex types, in accordance with the unified TCI state type and the one or more TCI states configured for the duplex type associated with the interval. Additionally or alternatively, the communication manager 150 may perform one or more other operations described herein.

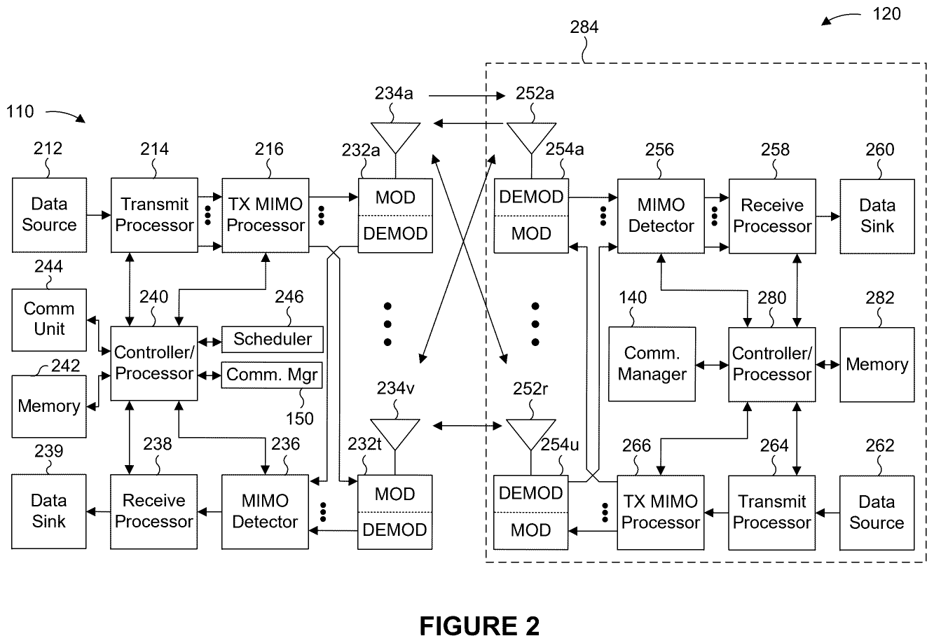

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include an uplink control information (UCI) communication, a MAC-CE communication, an RRC communication, or another type of uplink communication. Uplink signals may be transmitted on a physical uplink scheduled channel (PUSCH), a physical uplink control channel (PUCCH), and/or another type of uplink channel. An uplink signal may carry one or more transport blocks (TBs) of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal.

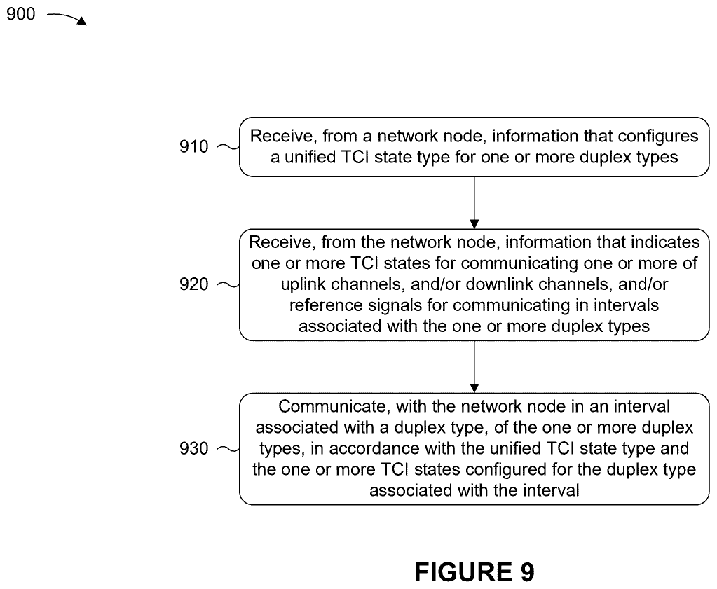

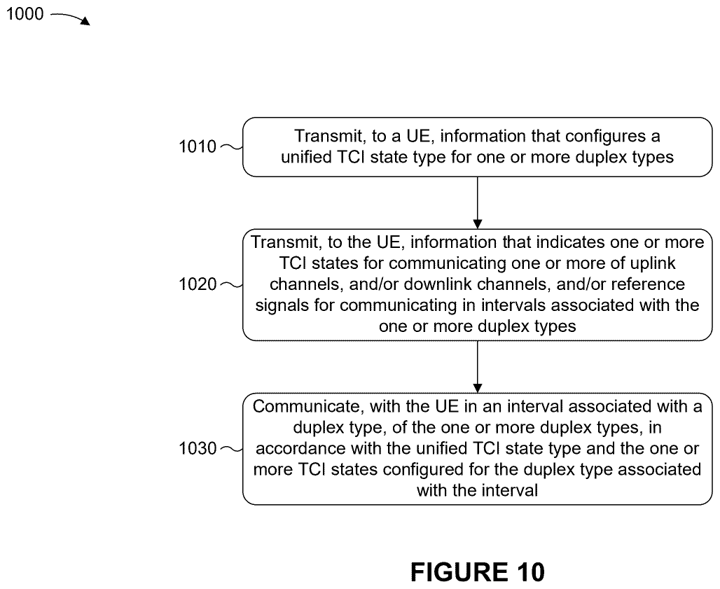

The network node 110, the controller/processor 240 of the network node 110, the UE 120, the controller/processor 280 of the UE 120, a CU, a DU, an RU, or any other component(s) of FIG. 1 or 2 may implement one or more techniques or perform one or more operations associated with a unified TCI state for time intervals associated with different duplex types, as described in more detail elsewhere herein. For example, the controller/processor 240 of the network node 110, the controller/processor 280 of the UE 120, any other component(s) of FIG. 2, the CU, the DU, or the RU may perform or direct operations of, for example, process 900 of FIG. 9, process 1000 of FIG. 10, or other processes as described herein (alone or in conjunction with one or more other processors). The memory 242 may store data and program codes for the network node 110, the network node 110, the CU, the DU, or the RU. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU, the DU, or the RU, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects, the UE 120 includes means for receiving, from a network node 110, information that configures a unified TCI state type for one or more duplex types; means for receiving, from the network node 110, information that indicates one or more TCI states for communicating one or more of uplink channels, downlink channels, or reference signals in intervals associated with the one or more duplex types; and/or means for communicating, with the network node 110 in an interval associated with a duplex type, of the one or more duplex types, in accordance with the unified TCI state type and the one or more TCI states configured for the duplex type associated with the interval. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE 120, information that configures a unified TCI state type for one or more duplex types; means for transmitting, to the UE 120, information that indicates one or more TCI states for communicating one or more of uplink channels, downlink channels, or reference signals in intervals associated with the one or more duplex types; and/or means for communicating, with the UE 120 in an interval associated with a duplex type, of the one or more duplex types, in accordance with the unified TCI state type and the one or more TCI states configured for the duplex type associated with the interval. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

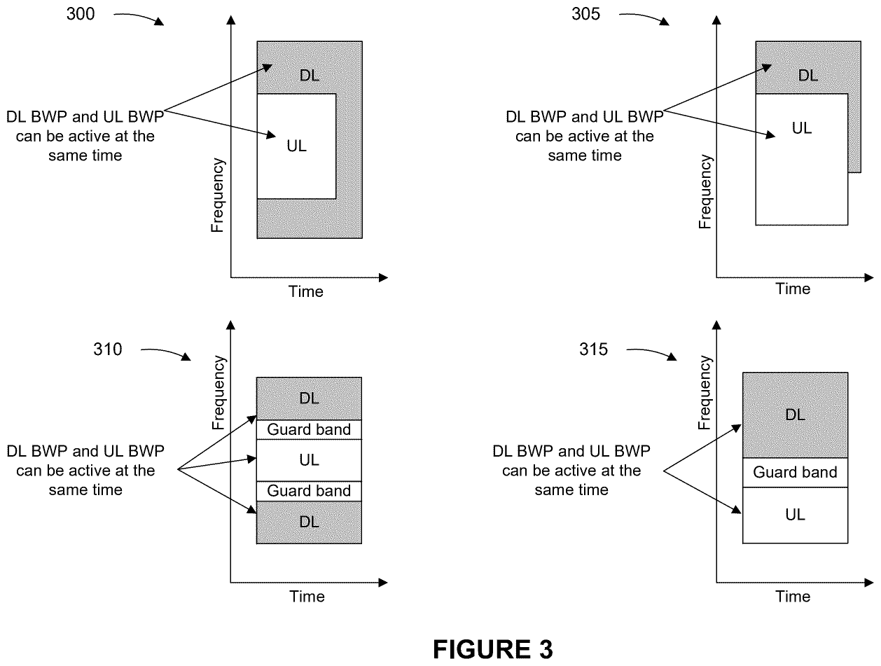

FIG. 3 is a diagram illustrating examples 300, 305, 310, and 315 of full-duplex communication. As described herein, “full-duplex communication” refers to simultaneous uplink and downlink communication in a wireless network, which may be a capability of a UE, a network node, or another suitable device (for example, a mobile termination (MT) component and/or a forwarding (FWD) component of a network-controlled repeater (NCR)). For example, a UE operating in a full-duplex mode may transmit an uplink communication and receive a downlink communication at the same time (for example, in the same slot or the same symbol), and a network node operating in a full-duplex mode may receive an uplink communication and transmit a downlink communication at the same time. “Half-duplex communication” in a wireless network refers to unidirectional communications (for example, only downlink communication or only uplink communication) at a given time (for example, a device only transmits or only receives in a given slot or a given symbol). In some examples, one or more nodes in a wireless network may support full-duplex communication and half-duplex communication, and other nodes may support half-duplex communication only. For example, in some aspects, a network node may support full-duplex and half-duplex communication, and one or more UEs may support half-duplex communication only.

As shown in FIG. 3, examples 300 and 305 show examples of in-band full-duplex (IBFD) communication. In a scenario where a network node supports IBFD and a UE supports half-duplex communication only, the network node may receive an uplink communication from a first UE and may transmit a downlink communication to a second UE on the same time and frequency resources. As shown in example 300, in a first example of IBFD, the time and frequency resources for uplink communication may fully overlap with the time and frequency resources for downlink communication (for example, all time and frequency resources allocated to uplink communication are also available for downlink communication). As shown in example 305, in a second example of IBFD, the time and frequency resources for uplink communication may partially overlap with the time and frequency resources for downlink communication (for example, some time and frequency resources are reserved for uplink communication only).

As further shown in FIG. 3, examples 310 and 315 show examples of SBFD communication, which may also be referred to as “sub-band frequency division duplex (SBFDD),” “flexible duplex,” or “FDD in unpaired spectrum.” In some aspects, an SBFD communication mode may be supported by a network node only, by a network node and a UE, by a UE only, and/or any suitable combination thereof. In the SBFD communication mode, a node operating in accordance with an SBFD configuration may simultaneously transmit and receive different communications at the same time, but on different frequency resources. For example, a network node operating in an SBFD mode may simultaneously receive an uplink communication from a first UE in an uplink sub-band and transmit a downlink communication to a second UE in a downlink sub-band, where the uplink sub-band and the downlink sub-band may occupy different frequency resources. Similarly, a UE operating in an SBFD mode may simultaneously transmit an uplink communication to a network node in an uplink sub-band and receive a downlink communication from the network node in a downlink sub-band. For example, the uplink sub-band and the downlink sub-band may be sub-bands of a frequency band, such as a TDD band, or a component carrier of a frequency band. In this case, the frequency resources used for downlink communication may be separated from the frequency resources used for uplink communication, in the frequency domain, by one or more guard bands. For example, as shown in example 310, SBFD communication may be configured in a D+U+D pattern, where an uplink sub-band is configured between a first (upper) downlink sub-band and a second (lower) downlink sub-band, with a first guard band separating the uplink sub-band from the first downlink sub-band and a second guard band separating the uplink sub-band from the second downlink sub-band. Additionally or alternatively, as shown in example 315, SBFD communication may be configured in a D+U pattern, where a component carrier bandwidth or frequency band is partitioned into a downlink sub-band and an uplink sub-band that are separated by a guard band.

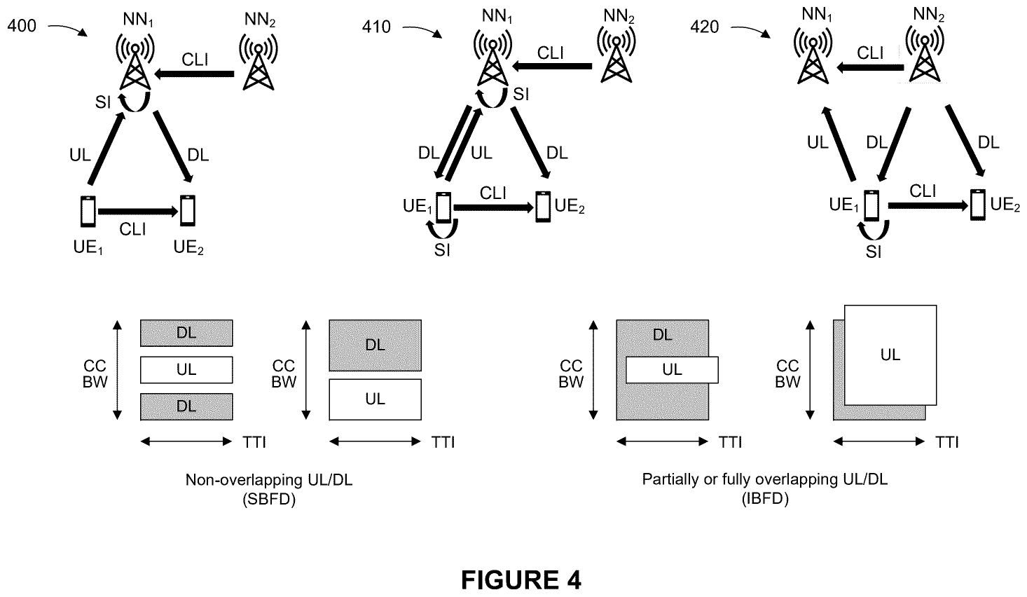

FIG. 4 is a diagram illustrating examples 400, 410, 420 of full-duplex deployments. As shown in FIG. 4, examples 400, 410, 420 include one or more UEs in communication with one or more network nodes in a wireless network that supports full-duplex communication. In general, as described herein, utilizing a full-duplexing communication mode may provide reduced latency by allowing a downlink transmission to occur in an uplink-only symbol or slot and/or by allowing an uplink transmission to occur in a downlink-only or flexible symbol or slot. In addition, full-duplex communication may increase an uplink duty cycle, which may improve uplink coverage, may enhance spectral efficiency or throughput per cell or per UE, may increase system capacity, may enable more efficient resource utilization by simultaneously utilizing time and frequency resources for downlink and uplink communication, and/or may enable flexible and dynamic uplink and downlink resource adaptation according to uplink and/or downlink traffic patterns. However, as described in further detail herein, full-duplexing communication modes may be associated with dynamic interference conditions.

For example, as shown in FIG. 4, example 400 includes a first UE (shown as UE₁) and a second UE (shown as UE₂) in communication with a first network node (shown as NN₁) operating in a full-duplexing mode, with the first UE and the second UE operating in a half-duplexing mode. For example, as shown in FIG. 4, the first UE may transmit one or more uplink transmissions to the first network node, and the second UE may concurrently receive one or more downlink transmissions from the first network node. Accordingly, in example 400, the first network node is operating in a full-duplexing mode, and the first UE and the second UE are each operating in a half-duplexing mode. As shown by example 400, there may be various forms of interference that may degrade downlink reception performance at one or more UEs and/or uplink reception performance at the first network node operating in the full-duplexing mode. For example, as shown, the first network node may experience cross-link interference (CLI) caused by downlink transmissions from a second network node (shown as NN₂) that may be located in an adjacent or nearby cell. Furthermore, as shown, the uplink transmission from the first UE to the first network node may cause CLI at the second UE (for example, CLI that interferes with downlink reception at the second UE). Furthermore, as shown, the first network node may experience self-interference, where the downlink transmission to the second UE interferes with reception of the uplink transmission from the first UE. For example, as described herein, self-interference may generally occur when a transmitted signal leaks into a receive port and/or when an object in a surrounding environment reflects a transmitted signal back to a receive port (for example, causing a clutter echo effect), thus interfering with reception of a desired signal at the receive port. In general, the full-duplexing mode used by the first network node in example 400 may be an SBFD mode, where a component carrier bandwidth is divided into an uplink sub-band and one or more downlink sub-bands that are separated by one or more guard bands. Additionally or alternatively, the full-duplexing mode may be an IBFD mode, where uplink and downlink resources fully or partially overlap.

As further shown in FIG. 4, in example 410, a first UE may communicate with a first network node in a full-duplexing mode. For example, in example 410, the first UE may receive one or more downlink transmissions from the first network node, and the first UE may concurrently transmit one or more uplink transmissions to the first network node. Accordingly, in example 410, the first network node and the first UE are both operating in a full-duplexing (for example, SBFD or IBFD) mode. Furthermore, as shown, the first network node may be communicating with a second UE operating in a half-duplexing mode. As shown by example 410, the first UE may experience self-interference, where the uplink transmission to the first network node interferes with reception of the downlink transmission from the first network node, and the first UE may cause CLI at the second UE, where the uplink transmission to the first network node interferes with downlink reception at the second UE. Additionally, in example 410, the first network node may experience CLI caused by one or more downlink transmissions from a second network node interfering with reception of the uplink transmission from the first UE, and the first network node may experience self-interference, where downlink transmission(s) to the first UE and/or the second UE interferes with reception of the uplink transmission from the first UE. In example 410, the full-duplex communication may be performed in an SBFD mode or an IBFD mode.

As further shown in FIG. 4, in example 420, a first UE may communicate with a first network node and a second network node in a full-duplexing mode (for example, a multi-TRP mode). For example, in example 420, the first UE may transmit one or more uplink transmissions to the first network node (for example, a first TRP), and the first UE may concurrently receive one or more downlink transmissions from the second network node (for example, a second TRP). Accordingly, in example 420, the first UE is operating in a full-duplexing mode, and the first and second network nodes are both operating in a half-duplexing mode. As shown by example 420, the first UE may experience self-interference, where the uplink transmission to the first network node interferes with reception of the downlink transmission from the second network node. Furthermore, the uplink transmission by the first UE may cause CLI at a second UE receiving a downlink transmission from the second network node. Furthermore, as shown, the downlink transmission by the second network node may cause CLI that interferes with uplink reception at the first network node. In example 420, the full-duplex communication may be performed in an SBFD mode or an IBFD mode.

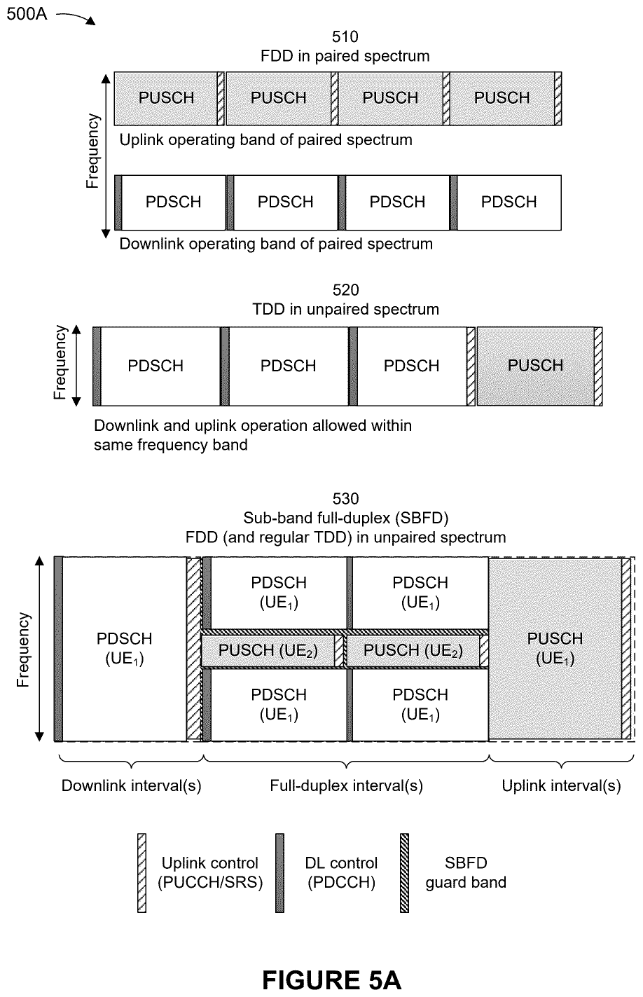

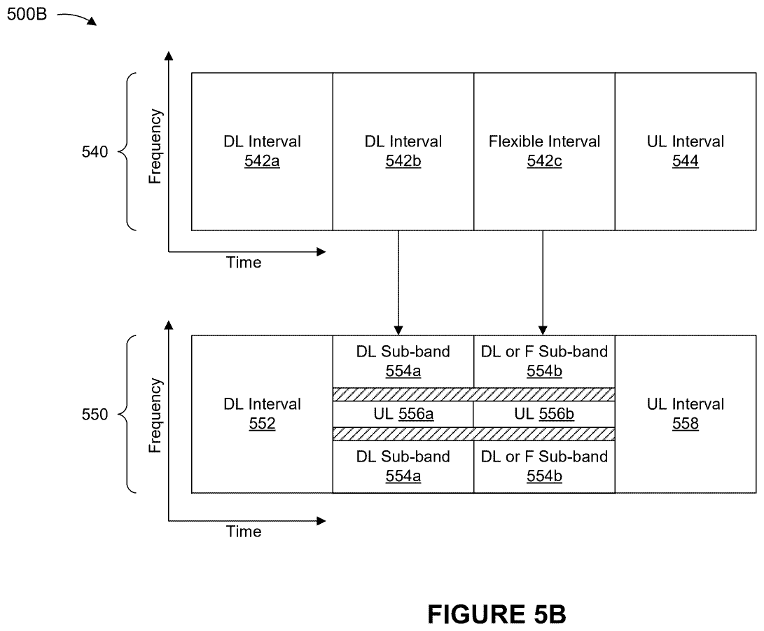

FIG. 5A is a diagram illustrating examples 500A of different duplexing modes, and FIG. 5B is a diagram illustrating an example 500B of SBFD activation. For example, as described in further detail herein, FIG. 5A illustrates an example 510 of an FDD mode that may be used in paired spectrum, an example 520 of a TDD mode that may be used in unpaired spectrum, and an example 530 of an SBFD mode that may be used in unpaired spectrum, and FIG. 5B illustrates an example 500B of techniques that may be used to activate the SBFD mode.

In some aspects, a wireless communication standard and/or governing body may generally specify one or more duplexing modes in which a wireless spectrum is to be used. For example, 3GPP may specify how wireless spectrum is to be used for a RAT and/or air interface. As an example, a specification may indicate whether a band is to be used as paired spectrum in an FDD mode, as unpaired spectrum in a TDD mode, or another duplexing mode (for example, SBFD).

For example, as shown by example 510, paired spectrum in the FDD mode may use a first frequency region (or channel) for uplink communication and a second frequency region (or channel) for downlink communication. In such cases, the frequency regions or channels used for uplink communication and downlink communication do not overlap, have different center frequencies, and have sufficient separation to prevent interference between the downlink communication and the uplink communication. For example, paired spectrum in FDD mode may include an uplink operating band and a downlink operating band that are configured to use non-overlapped frequency regions separated by a guard band. Accordingly, when operating in the FDD mode in paired spectrum, a network node or a UE with full-duplex capabilities may perform concurrent transmit and receive operations using the separate operating bands allocated to downlink and uplink communication. For example, paired bands in NR include NR operating bands n1, n2, n3, n5, n7, n8, n12, n20, n25, and n28, as specified by 3GPP Technical Specification (TS) 38.101-1.

Alternatively, as shown by example 520, unpaired spectrum in the TDD mode may allow downlink and uplink operation within a single frequency region (for example, a single operating band). For example, when operating in TDD mode in unpaired spectrum, downlink communication and uplink communication may occur in the same frequency resources. Some deployments may use TDD or a legacy half-duplexing mode in the unpaired band, whereby some TTIs (for example, frames, slots, and/or symbols) are used for downlink communication only and other TTIs are used for uplink communication only. In this case, substantially the entire bandwidth of a component carrier may be used for downlink communication or uplink communication, depending on whether the communication is performed in a downlink-only interval, an uplink-only interval, or a flexible interval (in which either downlink or uplink communication can be scheduled). Examples of unpaired bands include NR operating bands n40, n41, and n50, as specified by 3GPP TS 38.101-1. In some examples, however, using TDD in unpaired spectrum may be inefficient. For example, uplink transmit power may be limited, meaning that UEs may be incapable of transmitting with enough power to efficiently utilize the full component carrier bandwidth in an uplink interval. This may be particularly problematic in large cells at the cell edge. Furthermore, using TDD may introduce latency relative to a full-duplexing scheme in which uplink communications and downlink communications can be performed in the same time interval, because TDD restricts usage of a given TTI to uplink-only or downlink-only. Furthermore, using TDD may reduce spectral efficiency and/or reduce throughput by restricting usage of a given TTI to uplink-only or downlink-only.

Accordingly, as shown by example 530, an unpaired band may be configured in a full-duplexing mode to enable concurrent transmit and receive operations in unpaired spectrum (for example, a TDD band). For example, in FIG. 5A, example 530 depicts an SBFD mode, which may be referred to as full-duplexing in a frequency division multiplexing (FDM) mode or other suitable terminology, in order to enable TDD operation and/or FDD operation in unpaired spectrum. For example, as shown in FIG. 5A, an unpaired band configured in the SBFD mode may associate one or more TTIs with downlink communication only (for example, “D” slots), one or more TTIs for uplink communication only (for example, “U” slots), and one or more TTIs for both downlink communication and uplink communication (for example, “D+U” slots). Each TTI may be associated with a control region, illustrated as a portion of a time interval with a diagonal fill for uplink control (for example, a PUCCH) or a darker-shaded fill for downlink control (for example, a physical downlink control channel (PDCCH)). Additionally or alternatively, each TTI may be associated with a data region, which is shown as a physical downlink shared channel (PDSCH) for downlink frequency regions or a PUSCH for uplink frequency regions.

In some aspects, an unpaired band configured in the SBFD mode may include one or more downlink-only time intervals, one or more uplink-only time intervals, and/or one or more full-duplex time intervals (for example, frames, subframes, slots, and/or symbols, among other examples) that are associated with an FDD configuration. For example, as shown in FIG. 5A, the FDD configuration associated with a full-duplex time interval may indicate one or more downlink frequency regions (or sub-bands) and one or more uplink frequency regions (or sub-bands) that are separated by a guard band. For example, as shown by example 530, SBFD communication may be configured in a D+U+D pattern, where an uplink sub-band is configured between a first (upper) downlink sub-band and a second (lower) downlink sub-band, with a first guard band separating the uplink sub-band from the first downlink sub-band and a second guard band separating the uplink sub-band from the second downlink sub-band. Additionally or alternatively, SBFD communication may be configured in a D+U pattern (not explicitly shown in FIG. 5A), where a component carrier bandwidth or frequency band is partitioned into a downlink sub-band and an uplink sub-band that are separated by a guard band. Accordingly, an FDD configuration may divide an unpaired frequency band (for example, one or more component carriers of an unpaired band) into uplink frequency regions, downlink frequency regions, and/or other regions (for example, guard bands, and/or control regions), which may enable a network node or a UE with full-duplex capabilities to perform simultaneous transmit and receive operations during one or more full-duplex time intervals in which frequency resources are divided into downlink and uplink sub-bands with a guard band separation to prevent an uplink transmission from causing self-interference with respect to downlink reception. For example, in a given full-duplex time interval, a half-duplexing UE may either transmit using the uplink frequency region or receive in the downlink frequency region (for example, a UE communicating in a half-duplexing mode may only receive in a downlink frequency region or transmit in an uplink frequency region during the full-duplex time intervals). Alternatively, a full-duplexing UE may transmit using the uplink frequency region and/or receive in the downlink frequency region. Additionally or alternatively, a full-duplexing network node may transmit a downlink communication to a first UE within the downlink frequency regions(s) and simultaneously receive an uplink communication from a second UE in the uplink frequency region(s). In some aspects, the FDD configuration may identify BWP configurations corresponding to the uplink frequency regions and the downlink frequency regions. For example, a respective BWP may be configured for each uplink frequency region and each downlink frequency region.

Additionally or alternatively, full-duplexing may be enabled in unpaired spectrum in an IBFD mode, which may be referred to herein as full-duplexing in a spatial division multiplexing (SDM) mode. For example, in an IBFD mode or a full-duplexing in SDM mode, uplink communication may occur on time and frequency resources that fully overlap time and frequency resources allocated to downlink communication (for example, all of the time and frequency resources available for uplink communication are also available for downlink communication). Alternatively, uplink communication may occur on time and frequency resources that partially overlap with time and frequency resources available for downlink communication (for example, some time and frequency resources available for uplink communication are also available for downlink communication and some time and frequency resources available for uplink communication are uplink-only). In general, in the SBFD mode and/or the IBFD mode, full-duplex communication may be conditional on sufficient beam separation between an uplink beam and a downlink beam (for example, uplink transmission may be from one antenna panel and downlink reception may be in another antenna panel) in order to minimize self-interference that may occur when a transmitted signal leaks into a receive port and/or when an object in a surrounding environment reflects a transmitted signal back to a receive port (for example, causing a clutter echo effect).

In some examples, as described herein, one or more frequency regions that support SBFD communication may be configured to dynamically switch between operating in a TDD mode (for example, a half-duplexing mode in which each slot or symbol is uplink-only or downlink-only, also referred to as duplexing mode 1 and/or a legacy half-duplexing mode) and one or more SBFD modes. For example, in a scenario where only a network node supports SBFD operation, one or more downlink or flexible slots or symbols can be semi-statically or dynamically configured in a first SBFD mode (referred to as duplexing mode 2 and/or a network node SBFD mode) in which the network node simultaneously transmits a downlink communication to a first UE in one or more downlink sub-bands and receives an uplink communication from a second UE in an uplink sub-band, and any other slots or symbols may be configured in the legacy half-duplexing (for example, downlink-only or uplink-only). Furthermore, in cases where a UE supports SBFD operation, one or more slots or symbols can be configured in a second SBFD mode (referred to as duplexing mode 3 and/or a UE and network node SBFD mode) in which a network node operating in SBFD mode communicates with a UE operating in SBFD mode or in a third SBFD mode (referred to as duplexing mode 4 and/or a UE SBFD mode) in which a UE operating in SBFD mode communicates with a first TRP operating in a half-duplexing mode and a second TRP operating in a half-duplexing mode. In general, the second and third SBFD modes may be similar from a UE perspective, and may be transparent to an SBFD-capable UE in cases where two TRPs or cells are associated with the same cell or DU. Furthermore, although some aspects are described herein in relation to SBFD operation, the same or similar techniques may be applicable to partial or fully overlapping full-duplex (for example, IBFD) operation.

For example, as shown in FIG. 5B, a first configuration 540 (for example, a legacy or default configuration associated with the TDD mode) may indicate a first slot format pattern or TDD pattern associated with a half-duplex mode (for example, where each interval is downlink-only, uplink-only, or flexible such that the interval can be configured to be a downlink interval or an uplink interval). The first slot format pattern may include one or more downlink intervals (for example, shown as two downlink intervals 542a and 542b), one or more flexible intervals (for example, shown as one flexible interval 542c), and/or one or more uplink intervals (for example, shown as one uplink interval 544). The first slot format pattern may repeat over time. In some aspects, a network node 110 may indicate the first slot format pattern to a UE 120 using one or more slot format indicators. A slot format indicator, for a slot, may indicate whether the corresponding slot is an uplink slot, a downlink slot, or a flexible slot (for example, that can be used as an uplink or downlink slot).

A network node 110 may instruct (for example, using an indication, such as an RRC message, a MAC-CE, or a DCI message) a UE 120 to switch from the first configuration 540 to a second configuration 550. As an alternative, the UE 120 May indicate to the network node 110 that the UE 120 is switching from the first configuration 540 to the second configuration 550. The second configuration 550 may indicate a second slot format pattern that repeats over time, similar to the first slot format pattern. In some aspects, the UE 120 may switch from the first configuration 540 to the second configuration 550 during a time period (for example, a quantity of symbols and/or an amount of time) in accordance with an indication received from the network node 110 (for example, before switching back to the first configuration 540). During the time period, the UE 120 may communicate using the second slot format pattern, and then may revert to using the first slot format pattern after the end of the time period. The time period may be indicated by the network node 110 (for example, in the instruction to switch from the first configuration 540 to the second configuration 550, as described above) and/or associated with a programmed and/or otherwise preconfigured rule. For example, the rule may be based at least in part on a table (for example, defined in 3GPP specifications and/or another wireless communication standard) that associates different subcarrier spacings (SCSs) and/or numerologies (for example, represented by a u parameter and associated with corresponding SCSs) with corresponding time periods for switching configurations.

In example 500B, the second slot format pattern includes two SBFD intervals, which include a first SBFD interval in place of downlink interval 542b in the first slot format pattern and a second SBFD interval in place of flexible interval 542c in the first slot format pattern. In example 500B, the second slot format pattern includes a downlink interval 552, which is followed by the first SBFD interval that includes a downlink sub-band (for example, a portion of a frequency allocated for use by the network node 110 and the UE 120, shown as downlink sub-bands 554a) and an uplink sub-band (for example, shown as uplink sub-band 556a). For example, when an interval configured as downlink-only (for example, downlink interval 542b) is switched to or otherwise configured for SBFD operation, uplink transmissions within the uplink sub-band (for example, uplink sub-band 556a) are allowed within the interval, and uplink transmissions outside the uplink sub-band are not allowed within the interval. Furthermore, frequency locations of the downlink sub-band(s) (for example, downlink sub-bands 554a) can be explicitly indicated to the UE 120 or implicitly derived by the UE 120, and downlink reception within the downlink sub-band(s) is allowed in the interval.

As further shown in example 500B, the first SBFD interval is followed by a second SBFD interval, which includes one or more sub-bands that may be configured as downlink sub-bands or flexible sub-bands (for example, shown as sub-bands 554b) and an uplink sub-band (for example, shown as uplink sub-band 556b). For example, when an interval configured as flexible (for example, flexible interval 542c) is switched to or otherwise configured for SBFD operation, uplink transmissions within the uplink sub-band (for example, uplink sub-band 556b) are allowed within the interval, and uplink transmissions outside the uplink sub-band are not allowed within the interval. Alternatively, a set of resource blocks (RBs) outside the uplink sub-band 556b may be used for uplink communication, or for downlink communication excluding any guard bands, and a transmission direction for all RBs outside the uplink sub-band 556b is the same within the interval (for example, the UE 120 cannot use separate RBs outside the uplink sub-band 556b for downlink and uplink communication). Furthermore, frequency locations of the downlink sub-band(s) (for example, downlink sub-bands 554b) can be explicitly indicated to the UE 120 or implicitly derived by the UE 120, and downlink reception within the downlink sub-band(s) is allowed in the interval. As further shown, the second SBFD interval is followed by an uplink interval 558.

Accordingly, the UE 120 may operate using the second slot format pattern to transmit an uplink communication in an earlier interval (for example, the second interval in the sequence shown in FIG. 5B) as compared to using the first slot format pattern (for example, the fourth interval in sequence, shown as uplink interval 544). Other examples may include additional or alternative changes. For example, the second configuration 550 may indicate an SBFD interval in place of what was an uplink interval in the first configuration 540 (for example, uplink interval 544). In another example, the second configuration 550 may indicate a downlink interval or an uplink interval in place of what was an SBFD interval in the first configuration 540 (not shown in FIG. 5B). In yet another example, the second configuration 550 may indicate a downlink interval or an uplink interval in place of what was an uplink interval or a downlink interval, respectively, in the first configuration 540.

As described herein, an SBFD interval may generally include a frame, a slot, a symbol, or another TTI in which an SBFD configuration is used. An SBFD configuration may include a frequency resource configuration in which full duplex communication is supported (for example, for both uplink and downlink communications), with one or more frequencies or sub-bands used for uplink communication being separated from one or more frequencies or sub-bands used for downlink communication by a guard band. In some aspects, the SBFD configuration may include a single uplink sub-band and a single downlink sub-band separated by a guard band. In some aspects, the SBFD configuration may include multiple downlink sub-bands and a single uplink sub-band that is separated from the multiple downlink sub-bands by respective guard bands (for example, as shown in FIG. 5B). In some aspects, an SBFD configuration may include multiple uplink sub-bands and a single downlink sub-band that is separated from the multiple uplink sub-bands by respective guard bands. In some aspects, the SBFD configurations may include multiple uplink sub-bands and multiple downlink sub-bands, where each uplink sub-band is separated from a downlink sub-band by a guard band. In some aspects, operating using an SBFD mode may include activating or using a full-duplexing mode in one or more slots, symbols, or other intervals based at least in part on the one or more intervals having the SBFD configuration. An interval may support the SBFD mode if an uplink bandwidth part and a downlink bandwidth part are permitted to be or are simultaneously active in accordance with an SBFD configuration (for example, with guard band separation).

By switching from the first configuration 540 to the second configuration 550, the network node 110 and/or the UE 120 may experience increased quality and/or reliability of communications. For example, the network node 110 and the UE 120 may experience increased throughput (for example, using a full-duplex mode), reduced latency (for example, the UE 120 may be able to transmit an uplink and/or a downlink communication sooner using the second configuration 550 rather than the first configuration 540), increased network resource utilization (for example, by using both downlink frequency resources and uplink frequency resources simultaneously instead of only the downlink frequency resources or the uplink frequency resources), improved uplink coverage, and/or flexible and dynamic uplink and downlink resource adaptation according to uplink and downlink traffic patterns, among other examples.

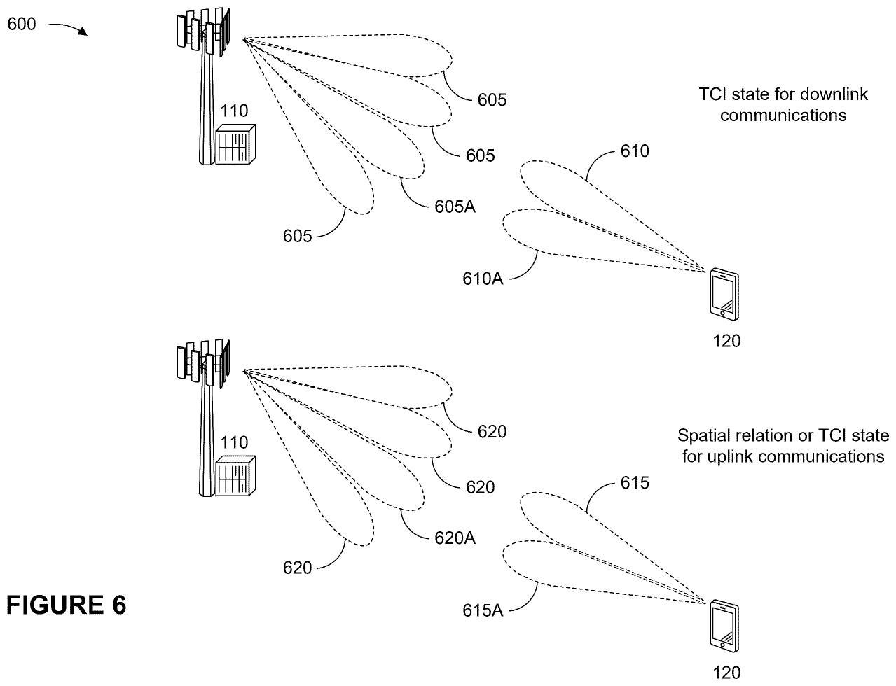

FIG. 6 is a diagram illustrating an example 600 of using beams for access link communications. As shown in FIG. 6, a network node 110 and a UE 120 may communicate with one another in a wireless network (for example, wireless network 100).

The network node 110 may transmit to UEs 120 located within a coverage area of the network node 110. The network node 110 and the UE 120 may be configured for beamformed communications, where the network node 110 may transmit in the direction of the UE 120 using a directional NN transmit beam (for example, a downlink transmit beam), and the UE 120 may receive the transmission using a directional UE receive beam (for example, a downlink receive beam). Each NN transmit beam may have an associated beam ID, beam direction, or beam symbols, among other examples. The network node 110 may transmit downlink communications via one or more NN transmit beams 605.

The UE 120 may attempt to receive downlink transmissions via one or more UE receive beams 610, which may be configured using different beamforming parameters at receive circuitry of the UE 120. The UE 120 may identify a particular NN transmit beam 605, shown as NN transmit beam 605A, and a particular UE receive beam 610, shown as UE receive beam 610A, that provide relatively favorable performance (for example, that have a best channel quality of the different measured combinations of NN transmit beams 605 and UE receive beams 610). In some examples, the UE 120 may transmit an indication of which NN transmit beam 605 is identified by the UE 120 as a preferred NN transmit beam, which the network node 110 may select for transmissions to the UE 120. The UE 120 may thus attain and maintain a beam pair link (BPL) with the network node 110 for downlink communications (for example, a combination of the NN transmit beam 605A and the UE receive beam 610A), which may be further refined and maintained in accordance with one or more established beam refinement procedures.

A downlink beam, such as an NN transmit beam 605 or a UE receive beam 610, may be associated with a TCI state. A TCI state may indicate a directionality or a characteristic of the downlink beam, such as one or more quasi co-location (QCL) properties of the downlink beam. A QCL property may include, for example, a Doppler shift, a Doppler spread, an average delay, a delay spread, or spatial receive parameters, among other examples. In some examples, each NN transmit beam 605 may be associated with a synchronization signal block (SSB), and the UE 120 may indicate a preferred NN transmit beam 605 by transmitting uplink transmissions in resources of the SSB that are associated with the preferred NN transmit beam 605. A particular SSB may have an associated TCI state (for example, for an antenna port or for beamforming). The network node 110 may, in some examples, indicate a downlink NN transmit beam 605 based at least in part on antenna port QCL properties that may be indicated by the TCI state. A TCI state may be associated with one downlink reference signal set (for example, an SSB and an aperiodic, periodic, or semi-persistent CSI-RS) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 610 at the UE 120. Thus, the UE 120 may select a corresponding UE receive beam 610 from a set of BPLs based at least in part on the network node 110 indicating an NN transmit beam 605 via a TCI indication.

The network node 110 may maintain a set of activated TCI states for downlink shared channel transmissions and a set of activated TCI states for downlink control channel transmissions. The set of activated TCI states for downlink shared channel transmissions may correspond to beams that the network node 110 uses for downlink transmission on a PDSCH. The set of activated TCI states for downlink control channel communications may correspond to beams that the network node 110 may use for downlink transmission on a PDCCH or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as an RRC message.

Similarly, for uplink communications, the UE 120 may transmit in the direction of the network node 110 using a directional UE transmit beam (for example, an uplink transmit beam), and the network node 110 may receive the transmission using a directional NN receive beam. Each UE transmit beam may have an associated beam ID, beam direction, or beam symbols, among other examples. The UE 120 may transmit uplink communications via one or more UE transmit beams 615.

The network node 110 may receive uplink transmissions via one or more NN receive beams 620 (for example, uplink receive beams). The network node 110 may identify a particular UE transmit beam 615, shown as UE transmit beam 615A, and a particular NN receive beam 620, shown as NN receive beam 620A, that provide relatively favorable performance (for example, that have a best channel quality of the different measured combinations of UE transmit beams 615 and NN receive beams 620). In some examples, the network node 110 may transmit an indication of which UE transmit beam 615 is identified by the network node 110 as a preferred UE transmit beam, which the network node 110 may select for transmissions from the UE 120. The UE 120 and the network node 110 may thus attain and maintain a BPL for uplink communications (for example, a combination of the UE transmit beam 615A and the NN receive beam 620A), which may be further refined and maintained in accordance with one or more established beam refinement procedures. An uplink beam, such as a UE transmit beam 615 or an NN receive beam 620, may be associated with a spatial relation. A spatial relation may indicate a directionality or a characteristic of the uplink beam, similar to one or more QCL properties, as described above.

Additionally or alternatively, as shown in FIG. 6, the network node 110 and the UE 120 may communicate using a unified TCI framework, in which case the network node 110 may indicate a TCI state that the UE 120 is to use for beamformed uplink communications. For example, in a unified TCI framework, a joint TCI state (which may be referred to as a joint downlink and uplink TCI state) may be used to indicate a common beam that the UE 120 is to use for downlink communication and uplink communication. In this case, the joint downlink and uplink TCI state may include at least one source reference signal to provide a reference (or UE assumption) for determining QCL properties for a downlink communication or a spatial filter for uplink communication. For example, the joint downlink and uplink TCI state may be associated with one or more source reference signals that provide common QCL information for UE-dedicated PDSCH reception and one or more CORESETs in a component carrier, or one or more source reference signals that provide a reference to determine one or more common uplink transmission spatial filters for a PUSCH transmission based on a dynamic grant or a configured grant or one or more dedicated PUCCH resources in a component carrier.

Additionally or alternatively, the unified TCI framework may support separate downlink and uplink TCI states to accommodate separate downlink and uplink beam indications (for example, in cases where a best uplink beam does not correspond to a best downlink beam, or vice versa, such as in an SBFD configuration where using the same beam for downlink and uplink communication may result in self-interference). In such cases, each valid uplink TCI state may be associated with a source reference signal to indicate an uplink transmit beam for a target uplink communication (for example, a target uplink reference signal or a target uplink channel). For example, the source reference signal may be an SRS, an SSB, or a CSI-RS, among other examples, and the target uplink communication may be a PRACH, a PUCCH, a PUSCH, an SRS, and/or a DMRS (for example, for a PUCCH or a PUSCH), among other examples. In this way, supporting joint TCI states or separate downlink and uplink TCI states may enable a unified TCI framework for downlink and uplink communications and/or may enable the network node 110 to indicate various uplink QCL relationships (for example, Doppler shift, Doppler spread, average delay, or delay spread, among other examples) for uplink TCI communication.

In a wireless network that supports the unified TCI framework, the network node 110 may transmit a DCI message that carries a TCI state indication to change a downlink beam, an uplink beam, and/or a joint downlink and uplink beam that the UE 120 uses to communicate with the network node 110, and the UE 120 may subsequently transmit hybrid automatic repeat request (HARQ) feedback to the network node 110 to acknowledge the TCI state indication. In general, the UE 120 may apply the TCI state indication starting from a first slot that is at least a configured number of symbols (for example, Y symbols) after a last symbol of an uplink transmission that carries the HARQ feedback. Accordingly, the configured number of symbols may generally define a beam application time that starts after the last symbol of the uplink transmission that carries the HARQ feedback and has a duration that depends on one or more active BWPs in one or more sets of component carriers applying the updated beam associated with the TCI state indication. For example, because the beam application time is based on a configured number of symbols, the duration of the beam application time may depend on a subcarrier spacing that defines a symbol duration for an active BWP.

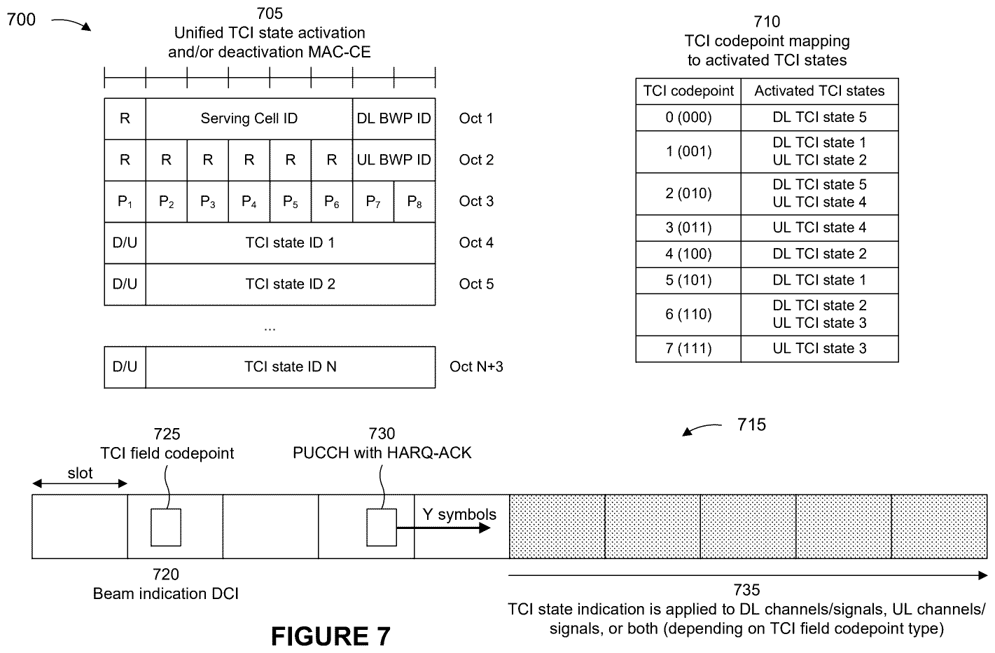

FIG. 7 is a diagram illustrating an example 700 of a TCI state indication in a unified TCI framework. In some aspects, example 700 illustrates a TCI state indication that may be provided in a beam indication DCI message in a unified TCI framework.

In a unified TCI framework, a network node 110 may configure a UE 120 with a unified TCI state type per component carrier. For example, an RRC configuration (per cell) may indicate (for example, in a unifiedTCI-StateType-r17 parameter) whether the unified TCI state type is associated with joint downlink and uplink TCI states, or separate downlink and uplink TCI states. For example, in cases where the UE 120 is configured with a joint TCI state that indicates a common beam that the UE 120 is to use for downlink and uplink communication, the network node 110 may configure the UE 120 with up to 128 TCI states (for example, indicated in a dl-OrJointTCI-StateList parameter) for downlink and uplink operation. In such cases, the joint TCI state can provide a reference signal for the QCL for a DMRS carried in a PDSCH, a DMRS carried in a PDCCH, and/or a CSI-RS and for determining an uplink transmission spatial filter for a dynamic PUSCH, a configured grant, a PUCCH, and/or an SRS. Alternatively, in cases where the UE 120 is configured with separate downlink and uplink TCI states, the UE 120 may be configured with up to 128 downlink TCI states (for example, in a dl-OrJointTCI-StateList parameter) for downlink operation and up to 64 uplink TCI states (for example, in an ul-TCI-ToAddModList parameter) for uplink operation. In such cases, the downlink TCI state can provide a source reference signal for the QCL for a DMRS carried in a PDSCH, a DMRS carried in a PDCCH, and/or a CSI-RS, and the uplink TCI state can be used to determine the uplink transmission spatial filter for a dynamic PUSCH, configured grant, PUCCH, and/or SRS.

As shown in FIG. 7, in the unified TCI framework, a network node 110 may transmit a TCI state activation and/or deactivation MAC-CE 705 that activates up to 8 TCI states and/or TCI state pairs that each include one downlink TCI state and one uplink TCI state, and a beam indication DCI message (for example, a DCI message associated with DCI format 1_1 or 1_2) may indicate one of the activated TCI states or one of the activated TCI state pairs. For example, as described herein, the TCI state activation and/or deactivation MAC-CE 705 may include one or more fields to indicate whether a TCI codepoint is associated with two TCI states (for example, separate downlink and uplink TCI states) or a single TCI state (for example, a joint downlink and uplink TCI state, an uplink-only TCI state, or a downlink-only TCI state). Additionally or alternatively, the TCI state activation MAC-CE 705 may indicate a mapping between a TCI codepoint carried in the beam indication DCI message and any suitable combination of a first downlink TCI state, a first uplink TCI state, a second downlink TCI state, and a second uplink TCI state. In some aspects, the beam activation DCI message may include a downlink grant that schedules a PDSCH, or the beam activation DCI message may be transmitted without a PDSCH assignment.

As described herein, the TCI state activation and/or deactivation MAC-CE 705 has a variable size that includes various fields. For example, as shown in FIG. 7, the TCI state activation and/or deactivation MAC-CE 705 includes a serving cell identifier (ID) field that indicates an identity of a serving cell associated with the TCI state activation and/or deactivation MAC-CE 705, a downlink bandwidth part (BWP) field that indicates a downlink BWP associated with the TCI state activation and/or deactivation MAC-CE 705, and an uplink BWP field that indicates an uplink BWP associated with the TCI state activation and/or deactivation MAC-CE 705. As further shown, the TCI state activation and/or deactivation MAC-CE 705 includes a set of fields, Pᵢ, that each have a first value (for example, 1) to indicate that the i^{th} TCI codepoint has multiple TCI states (for example, downlink and uplink TCI states) or a second value (for example, 0) to indicate that the i^{th} TCI codepoint has a single TCI states (for example, a downlink-only TCI state, an uplink-only TCI state, or a joint downlink and uplink TCI state). The Pᵢ fields are followed by one or more octets associated with one or more respective TCI states that are activated. For example, as shown by FIG. 7, each octet includes a D/U field to indicate whether the TCI state indicated in the same octet is a downlink-only TCI state, an uplink-only TCI state, or a joint downlink and uplink TCI state, and a TCI state ID field indicating the TCI state.

Accordingly, as described herein, the TCI state activation and/or deactivation MAC-CE 705 may activate up to 8 TCI codepoints that may be mapped to one or more TCI states. For example, FIG. 7 illustrates an example TCI codepoint mapping 710 for separate downlink and uplink TCI states, where each TCI codepoint can be mapped to one downlink TCI state, one uplink TCI state, or separate downlink and uplink TCI states. Alternatively, in the case of a joint downlink and uplink unified TCI state (for example, for single TRP operation), each TCI codepoint may be mapped to one joint TCI state. In examples where the TCI state activation and/or deactivation MAC-CE 705 maps a downlink TCI state or an uplink TCI state to a single TCI codepoint, the TCI state may be applied to all downlink or uplink signals and/or channels. In such cases, a DCI-based beam indication may not be needed. Otherwise, where the TCI state activation and/or deactivation MAC-CE 705 maps a downlink TCI state or an uplink TCI state to multiple TCI codepoints, a DCI message with a TCI field may be provided to indicate one of the TCI codepoints. In such examples, when a network node 110 transmits a beam indication DCI message to indicate a downlink TCI state, an uplink TCI state, or a joint TCI state, the TCI state indication may be unrelated to a scheduled PDSCH, and is not a one-time indication. Instead, when the TCI state indication is applied (for example, as shown in FIG. 7), the indicated TCI state remains applicable to the associated channels and/or signals until another beam indication DCI messages indicates a different TCI state. Furthermore, an application time for the TCI state indicated in the beam indication DCI message is the first slot that is at least Y symbols after the last symbol of a PUCCH that carries HARQ-ACK feedback for the beam indication DCI message. For example, as shown in FIG. 7, a network node 110 May transmit, and a UE 120 may receive, a beam indication DCI message 720 that includes a TCI field codepoint 725, where the beam indication DCI message 720 is received at the UE 120 after a TCI state activation MAC-CE 705 has activated two or more TCI states (for example, the beam indication DCI message 720 may be unnecessary if the TCI state activation MAC-CE activates only one TCI state). Accordingly, the TCI field codepoint 725 may be mapped to one TCI state or one TCI state pair (one downlink TCI state and one uplink TCI state) among the TCI states that were activated by the TCI state activation MAC-CE 705. As further shown in FIG. 7, the UE 120 may then transmit a PUCCH 730 that includes HARQ-ACK feedback for the beam indication DCI message. As shown by reference number 35, the TCI state indication may then be applied to downlink channels and/or signals, uplink channels and/or signals, or both (for example, depending on the type of the TCI field codepoint 725), starting in the first slot that is at least Y symbols after a last symbol of the PUCCH 730 carrying the HARQ-ACK feedback (for example, where Y has a value that is RRC-configured in accordance with a capability of the UE 120).

In some aspects, when a network node 110 uses DCI format 1_1 or DCI format 1_2 to provide a beam indication, a cyclic redundancy code (CRC) associated with the beam indication DCI message may be scrambled using a configured scheduling radio network temporary identifier (CS-RNTI). Furthermore, the beam indication DCI message may include a redundancy version (RV) field with all bits set to 1, an MCS field with all bits set to 1, a new data indicator (NDI) field set to 0, and a frequency domain resource allocation (FDRA) field set with all bits set to 0 for a first FDRA type (for example, FDRA type 0) or for a dynamicSwitch or with all bits set to 1 for a second FDRA type (for example, FDRA type 1). Furthermore, the beam indication DCI message includes a TCI field that is always present to indicate a “sticky” TCI codepoint among multiple TCI codepoints that were activated in a TCI state activation MAC-CE (for example, corresponding to an uplink-only TCI state, a downlink-only TCI state, a joint uplink and downlink TCI state, and/or separate uplink and downlink TCI states). Furthermore, in some aspects, the beam indication DCI message may include fields to indicate a DCI format identifier, a carrier indicator, a BWP indicator, a time domain resource allocation (TDRA), a downlink assignment index (if configured), a TPC command for a scheduled PUCCH, a PUCCH resource indicator, and/or a PDSCH-to-HARQ feedback timing indicator (if present). Furthermore, in some examples, the beam indication DCI message may include one or more unused DCI fields and/or codepoints (for example, a HARQ process number (HPN) field).

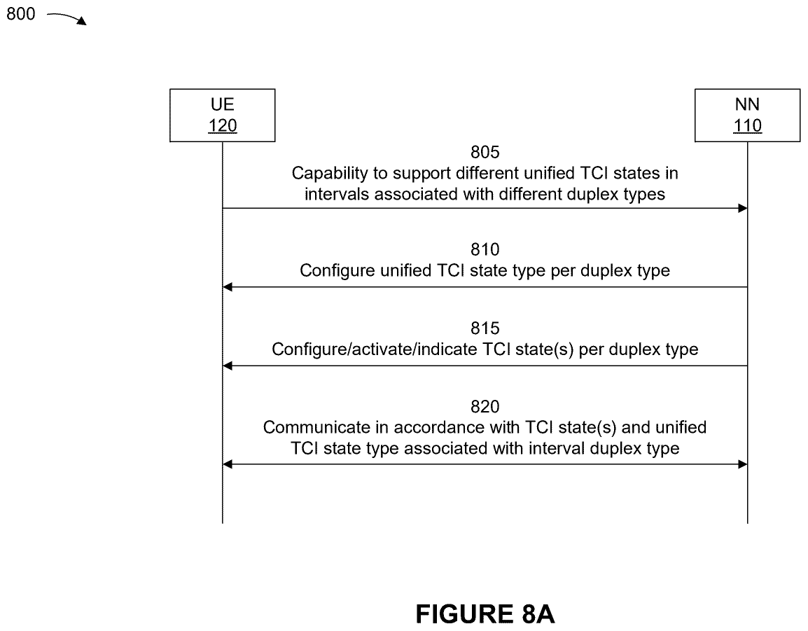

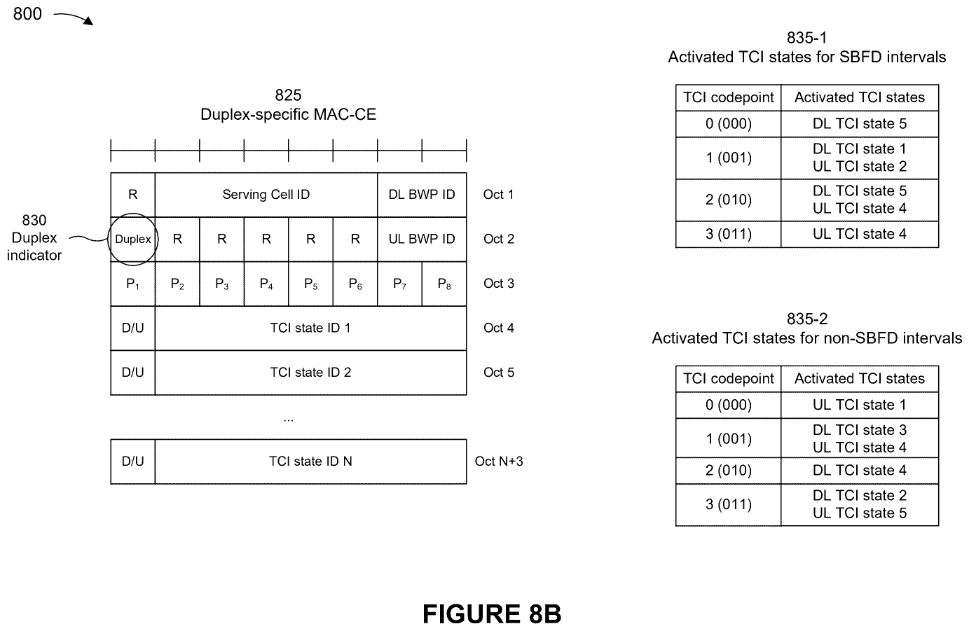

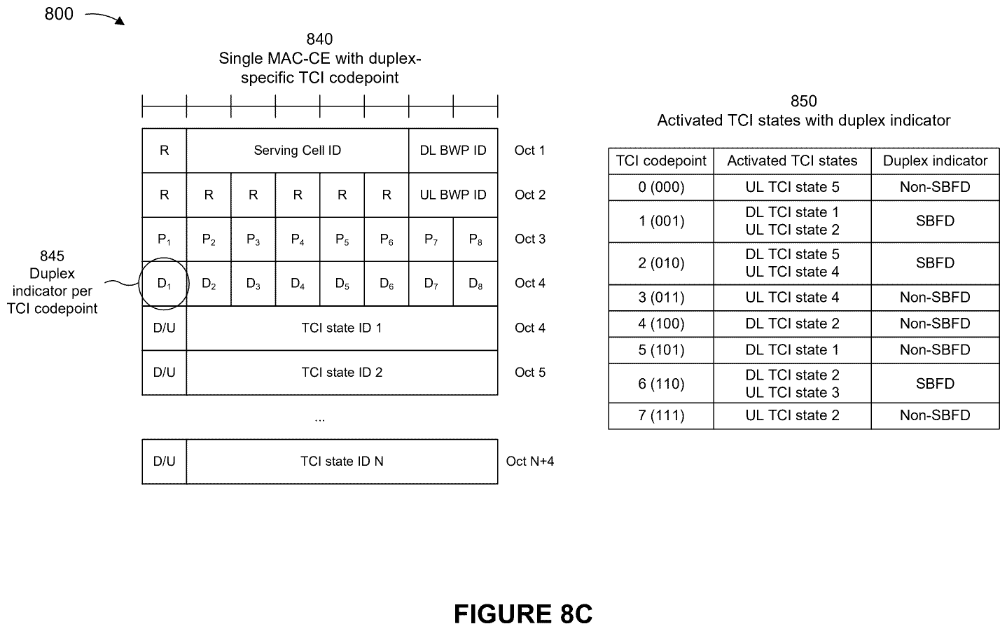

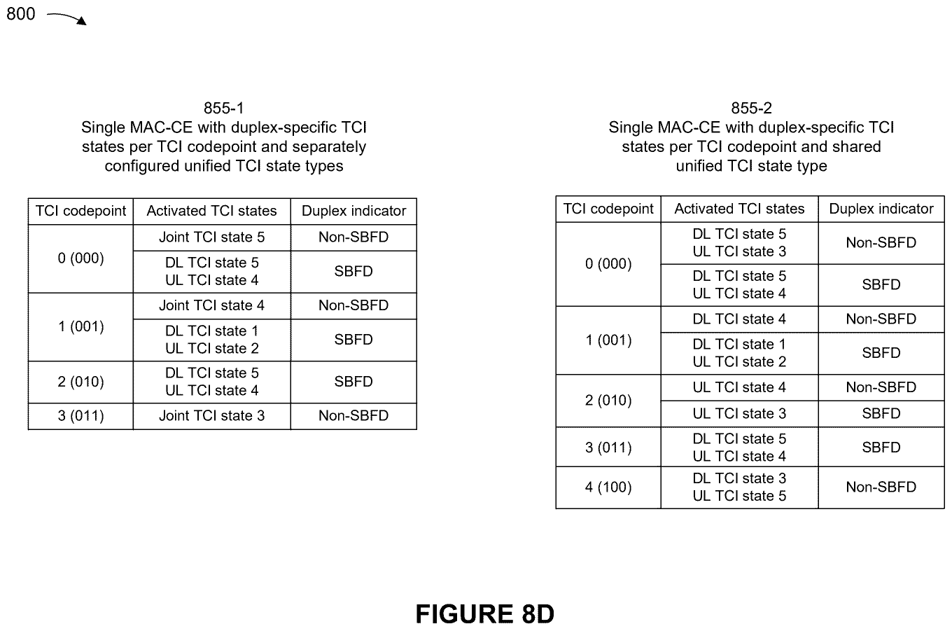

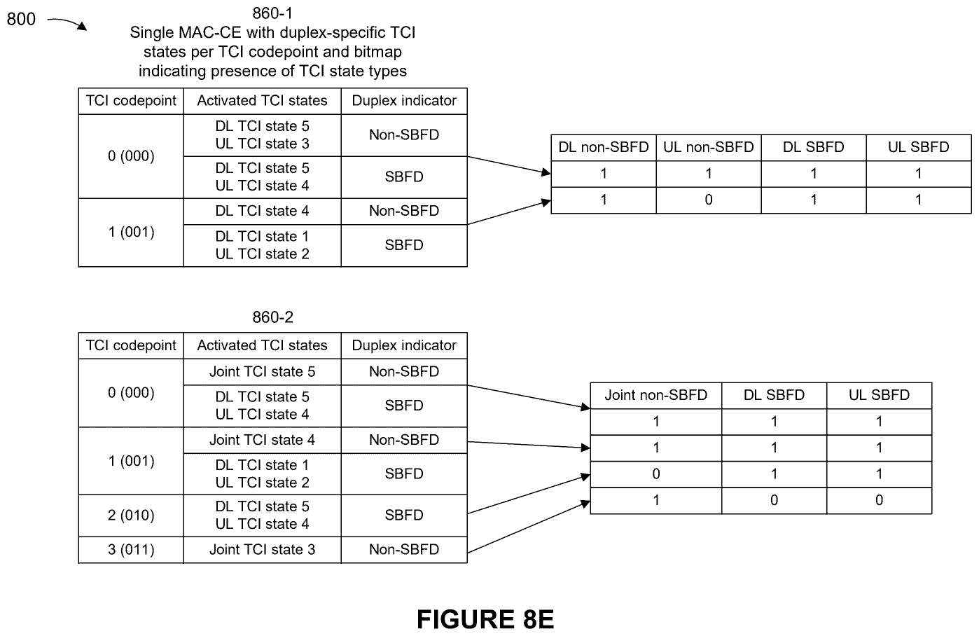

FIGS. 8A-8E are diagrams illustrating examples 800 of a unified TCI state for time intervals associated with different duplex types. As shown in FIG. 8A, examples 800 include communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

As described herein, SBFD operation may be a capability supported only by the network node 110, only by the UE 120, or by both the network node 110 and the UE 120. Furthermore, the network node 110 and the UE 120 may generally support a legacy half-duplex communication mode, where the network node 110 only transmits a downlink communication to the UE 120 or only receives an uplink communication from the UE 120 in any particular TTI. Accordingly, in some examples, a duplexing mode or duplexing configuration can be semi-statically or dynamically switched or otherwise configured in different TTIs, such as different symbols or slots (for example, depending on one or more conditions, such as self-interference at a network node or a UE that supports SBFD operation, an uplink and/or downlink traffic demand, and/or an uplink and/or downlink traffic periodicity, among other examples). For example, in any particular TTI, communication may be configured in a legacy half-duplexing mode (for example, where the network node 110 and the UE 120 communicate using half-duplexing), a network node SBFD mode (for example, where the network node 110 operates in SBFD mode and simultaneously communicates on a downlink with a first UE 120 and on an uplink with a second UE 120), a network node and UE SBFD mode (for example, where the network node 110 and the UE 120 both operate in an SBFD mode), or a UE SBFD mode (for example, where the UE 120 operates in SBFD mode and simultaneously communicates on a downlink with a first TRP and on an uplink with a second TRP). However, enabling SBFD and non-SBFD operation in different TTIs poses challenges because a wireless channel may be subject to different conditions in SBFD symbols and non-SBFD symbols. For example, SBFD operation may depend on spatial separation between uplink and downlink beams to mitigate self-interference, whereas a common beam may be used for uplink and downlink communication in non-SBFD symbols. In another example, an uplink and downlink beam pair that best minimizes interference may vary in SBFD and non-SBFD symbols. Furthermore, separate uplink power control may be appropriate for uplink transmissions in SBFD and non-SBFD symbols (for example, an uplink transmit power may be reduced in SBFD symbols to mitigate self-interference or cross-link interference).

Accordingly, various aspects described herein relate generally to techniques to configure and indicate separate TCI states under a unified TCI framework for SBFD and non-SBFD symbols. Although some aspects are described herein with respect to SBFD and non-SBFD symbols, the same techniques may be applied for any suitable time interval, such as a slot, a frame, and/or a subframe, among other examples.

As shown in FIG. 8A, in a first operation 805, the UE 120 may transmit, and the network node 110 may receive, information indicating that the UE 120 has a capability to support different unified TCI states in intervals associated with different duplex types, such as SBFD symbols and non-SBFD (for, example, half-duplex) symbols. For example, in some aspects, the UE 120 may have a capability to communicate in an SBFD mode and a non-SBFD mode and may support different unified TCI states in SBFD and non-SBFD symbols. Additionally or alternatively, the UE 120 may be SBFD-aware and may have a capability to support different unified TCI states in symbols where the network node 110 communicates in an SBFD mode and symbols when the network node 110 communicates in a non-SBFD mode.

Accordingly, the network node 110 may configure and indicate unified TCI states that the UE 120 is to use to communicate in SBFD and non-SBFD symbols in accordance with the UE 120 indicating the capability to support different unified TCI states in SBFD time intervals and non-SBFD time intervals.

For example, as shown in FIG. 8A, in a second operation 810, the network node 110 may transmit, and the UE 120 may receive, information that configures a unified TCI state type for one or more duplex types. For example, each duplex type, such as SBFD and non-SBFD, may be associated with a separate unified TCI state type, where the UE 120 is configured to communicate using a downlink TCI state and a separate uplink TCI state, or with a joint unified TCI state type, where the UE 120 is configured to communicate using a joint downlink and uplink TCI state. In some aspects, the unified TCI state type may be configured separately for each duplex type. For example, in some aspects, the network node 110 may indicate (for example, in a unifiedTCI-StateType-r17 parameter) that non-SBFD intervals are associated with a separate or joint unified TCI state type and may separately indicate (for example, in a unifiedTCI-StateType-r19-SBFD parameter) that SBFD intervals are associated with a separate or joint unified TCI state type. In this way, downlink and uplink communication in non-SBFD symbols can be configured and indicated with a joint downlink and uplink TCI state (for example, a common downlink and uplink beam), and downlink and uplink communication in SBFD symbols can be configured and indicated with separate downlink and uplink TCI states (for example, to mitigate self-interference, cross-link interference, or other dynamic interface in SBFD symbols).

Alternatively, downlink and uplink communication in non-SBFD symbols can be configured and indicated with separate downlink and uplink TCI states, and downlink and uplink communication in SBFD symbols can be configured and indicated with a joint downlink and uplink TCI state, or the same unified TCI state type may be configured for SBFD and non-SBFD symbols. In this way, separately configuring the unified TCI state type per duplex type may provide flexibility to configure and indicate unified TCI states according to the conditions associated with each duplex type. Furthermore, in cases where the unified TCI state type per duplex type is configured separately per duplex type, each duplex type may be associated with a respective TCI state pool, or a TCI state pool may be shared by the different duplex types. For example, in some aspects, SBFD intervals may be associated with a first TCI state pool and non-SBFD intervals may be associated with a second TCI state pool (for example, with each TCI state pool including up to 64 candidate TCI states). Alternatively, a single TCI state pool may be shared for SBFD intervals and non-SBFD intervals (for example, with up to 32 candidate TCI states per duplex type).

Alternatively, in some aspects, the network node 110 may configure the same unified TCI state type for each duplex type. For example, when the network node 110 configures a separate unified TCI state type, uplink and downlink TCI states may be separately configured and indicated for SBFD and non-SBFD intervals. Similarly, when a joint unified TCI state type is configured, joint uplink and downlink TCI states may be configured and indicated for SBFD intervals and non-SBFD intervals.

As further shown in FIG. 8A, in a third operation 815, the network node 110 may transmit, and the UE 120 may receive, information that configures, activates, and/or indicates one or more TCI states for each duplex type. For example, in some aspects, the network node 110 may configure, activate, and/or indicate a joint downlink and uplink TCI state and/or separate downlink and uplink TCI states to be used in SBFD symbols, and may configure, activate, and/or indicate a joint downlink and uplink TCI state and/or separate downlink and uplink TCI states to be used in non-SBFD symbols (for example, in accordance with the unified TCI state type configured for each duplex type). In this way, the network node 110 may configure, activate, and/or indicate one or more unified TCI states for communicating downlink channels and/or reference signals, and/or uplink channels and/or reference signals, in SBFD intervals, and may configure, activate, and/or indicate one or more unified TCI states for communicating downlink channels and/or reference signals, and/or uplink channels and/or reference signals, in non-SBFD intervals. Accordingly, in a fourth operation 820, the UE 120 and the network node 110 may communicate in an interval in accordance with a duplex type associated with the interval and the unified TCI state(s) that are configured, activated, and/or indicated for the duplex type associated with the interval. For example, in an SBFD interval, the UE 120 and the network node 110 may communicate using a joint TCI state or separate downlink and uplink TCI states associated with the SBFD duplex type, and may communicate using a joint TCI state or separate downlink and uplink TCI states associated with the non-SBFD duplex type in non-SBFD intervals. In this way, different (or the same) uplink and downlink beams may be used in SBFD and non-SBFD intervals, and various other parameters (such as uplink power control) may be independently controlled according to the TCI state(s) configured for SBFD intervals and the TCI state(s) configured for non-SBFD intervals.

In some aspects, as described herein, the network node 110 may generally configure, activate, and/or indicate the unified TCI state(s) to be used in SBFD intervals and the TCI state(s) to be used in non-SBFD intervals using one or more RRC messages, one or more MAC-CEs, and/or one or more DCI messages.

For example, in some aspects, the network node 110 may transmit, and the UE 120 may receive, an RRC message that configures a single uplink TCI state, a single downlink TCI state, or a single joint TCI state under the unified TCI framework, and may indicate whether the single uplink TCI state, downlink TCI state, or joint TCI state is associated with SBFD intervals, non-SBFD intervals, or both SBFD and non-SBFD intervals. For example, in some aspects, the RRC message may include a duplex type field that may have a first value (for example, “SBFD”) to indicate that the single uplink TCI state, downlink TCI state, or joint TCI state is associated with SBFD intervals or a second value (for example, “non-SBFD”) to indicate that the single uplink TCI state, downlink TCI state, or joint TCI state is associated with non-SBFD intervals. Alternatively, in some aspects, the RRC message may omit the duplex type field, and the absence of the duplex type field may implicitly indicate that the single uplink TCI state, downlink TCI state, or joint TCI state is associated with SBFD and non-SBFD intervals. The network node 110 and the UE 120 may then use the indicated TCI state for all applicable channels and/or reference signals associated with the indicated TCI state (for example, a PUCCH, PUSCH, and SRS in SBFD symbols where the indicated TCI state is an uplink-only TCI state or a joint TCI state for SBFD symbols or SBFD and non-SBFD symbols, among other examples).

Additionally or alternatively, the network node 110 may transmit, and the UE 120 may receive, an RRC message that configures multiple uplink TCI states, multiple downlink TCI states, and/or multiple joint TCI states under the unified TCI framework, and may indicate which TCI states are for SBFD symbols and which TCI states are for non-SBFD symbols (where different uplink and downlink TCI states may be configured for full-duplex operation that may depend on spatial separation between uplink and downlink beams). For example, in some aspects, each TCI state may be associated with a duplex type field indicating that the TCI state is associated with SBFD or non-SBFD intervals. Alternatively, in some aspects, the duplex type field may be omitted for one or more TCI states, and the absence of the duplex type field may implicitly indicate that the corresponding TCI state is associated with SBFD and non-SBFD intervals.

Additionally or alternatively, as shown in FIG. 8B, the network node 110 may provide an RRC configuration that configures multiple uplink TCI states, multiple downlink TCI states, and/or multiple joint TCI states under the unified TCI framework, and the network node 110 may subsequently transmit, and the UE 120 may receive, a respective TCI state activation MAC-CE 825 for each duplex type. For example, in some aspects, the UE 120 may receive a first TCI state activation MAC-CE 825 for SBFD intervals, and may receive a second TCI state activation MAC-CE 825 for SBFD intervals. Accordingly, each duplex-specific TCI state activation MAC-CE 825 may activate one or more TCI codepoints for a given duplex type. For example, as shown in FIG. 8B, the duplex-specific TCI state activation MAC-CE 825 may include a duplex type field or duplex indicator 830 (for example, corresponding to a reserved bitfield in the unified TCI state activation and/or deactivation MAC-CE 705 shown in FIG. 7), which may have a first value (for example, 0) to indicate that the duplex-specific TCI state activation MAC-CE 825 activates one or more TCI codepoints for SBFD intervals, or a second value (for example, 1) to indicate that the duplex-specific TCI state activation MAC-CE 825 activates one or more TCI codepoints for non-SBFD intervals.

Alternatively, in some aspects, the duplex type associated with the duplex-specific TCI state activation MAC-CE 825 may be implicit, in accordance with a slot type in which the duplex-specific TCI state activation MAC-CE 825 is transmitted by the network node 110 and received by the UE 120 (for example, the duplex-specific TCI state activation MAC-CE 825 may activate TCI codepoints for SBFD intervals if transmitted and received in an SBFD slot, or may activate TCI codepoints for non-SBFD intervals if transmitted and received in a non-SBFD slot). In this way, the UE 120 may receive separate MAC-CEs that each activate up to 8 TCI codepoints (that are each mapped to one or two TCI states) for a respective duplex mode. For example, as shown in FIG. 8B, the UE 120 may receive a first duplex-specific MAC-CE 825 that activates a first set of TCI states 835-1 for SBFD intervals, and may receive a second duplex-specific MAC-CE 825 that activates a second set of TCI states 835-2 for non-SBFD intervals. In the illustrated example, SBFD intervals and non-SBFD intervals are each associated with a separate unified TCI state type, whereby each TCI codepoint in the first set of TCI states 835-1 and the second set of TCI states 835-2 is mapped to an uplink TCI state, a downlink TCI state, or a downlink TCI state and an uplink TCI state.

Additionally or alternatively, as shown in FIG. 8C, the network node 110 may provide an RRC configuration that configures multiple uplink TCI states, multiple downlink TCI states, and/or multiple joint TCI states under the unified TCI framework, and the network node 110 may subsequently transmit, and the UE 120 may receive, a single TCI state activation MAC-CE 840 that activates multiple duplex-specific TCI codepoints. For example, in some aspects, the TCI state activation MAC-CE 840 may activate one or more TCI codepoints for SBFD intervals and one or more TCI codepoints for non-SBFD intervals, and the TCI state activation MAC-CE 840 may include a duplex indicator 845 for each TCI codepoint to indicate whether the corresponding TCI codepoint is applicable for SBFD or non-SBFD intervals. For example, as shown in FIG. 8C, the duplex indicator 845 for an i^{th} TCI codepoint may be denoted Di, where the duplex indicator 845 may have a first value (for example, 0) to indicate that the TCI states associated with the i^{th} TCI codepoint are applicable for SBFD intervals only, or the duplex indicator 845 may have a second value (for example, 1) to indicate that the TCI states associated with the i^{th} TCI codepoint are applicable for non-SBFD intervals only. For example, FIG. 8C illustrates a set of activated TCI states 850 with a duplex indicator, where each TCI codepoint is mapped to up to 2 TCI states (such as a downlink-only TCI state, an uplink-only TCI state, separate downlink and uplink TCI states, or a joint downlink and uplink TCI state). As further shown, each TCI codepoint that is activated by the TCI state activation MAC-CE 840 is associated with a duplex indicator that indicates whether the TCI state(s) mapped to the respective TCI codepoint are applicable for SBFD or non-SBFD intervals.

Additionally or alternatively, as shown in FIG. 8D, the network node 110 may provide an RRC configuration that configures multiple uplink TCI states, multiple downlink TCI states, and/or multiple joint TCI states under the unified TCI framework, and the network node 110 may subsequently transmit, and the UE 120 may receive, a single TCI state activation MAC-CE that activates one or more TCI codepoints, with each TCI codepoint mapping to up to four TCI states. In particular, each TCI codepoint that is activated in the TCI state activation MAC-CE may be mapped to up to two TCI states for SBFD intervals (for example, a downlink TCI state, an uplink TCI, separate downlink and uplink TCI states, or a joint TCI state) and/or may be similarly mapped to up to two TCI states for non-SBFD intervals. Furthermore, each TCI codepoint may be associated with one or more duplex indicators to indicate the duplex type associated with the TCI state(s) mapped to the TCI codepoint.

For example, FIG. 8D illustrates a set of activated TCI codepoints 855-1 where a unified TCI state type is separately configured for SBFD and non-SBFD intervals (for example, a separate unified TCI state type is configured for SBFD intervals and a joint unified TCI state type is configured for non-SBFD intervals). In this example, each TCI codepoint may be mapped to a joint TCI state for non-SBFD intervals, up to two TCI states for SBFD intervals, or a combination of a joint TCI state for non-SBFD intervals and up to two TCI states for SBFD intervals. For example, TCI codepoints 0 and 1 are mapped to a joint TCI state for non-SBFD intervals and separate downlink and uplink TCI states for SBFD intervals, TCI codepoint 2 is mapped to separate downlink and uplink TCI states for SBFD intervals, and TCI codepoint 3 is mapped to a joint TCI state for non-SBFD intervals. In another example, FIG. 8D illustrates a set of activated TCI codepoints 855-2 where SBFD and non-SBFD intervals share a unified TCI state type (for example, a separate unified TCI state type is configured for SBFD intervals and non-SBFD intervals). In this example, each TCI codepoint may be mapped to up to two TCI states for non-SBFD intervals and/or up to two TCI states for SBFD intervals (for example, a downlink-only TCI state, an uplink-only TCI state, or separate downlink and uplink TCI states for one or both duplex types). In this example, TCI codepoints 0-2 are mapped to separate downlink and uplink TCI states for SBFD and non-SBFD intervals, TCI codepoint 3 is mapped to separate downlink and uplink TCI states for SBFD intervals only, and TCI codepoint 4 is mapped to separate downlink and uplink TCI states for non-SBFD intervals only.

In some aspects, when a single TCI state activation MAC-CE activates one or more TCI codepoints that each map to up to four TCI states (up to two for SBFD intervals and/or up to two for non-SBFD intervals), the TCI state activation MAC-CE may include a bitmap field that indicates the presence or absence of TCI states associated with each duplex type. For example, FIG. 8E illustrates an example set of activated TCI codepoints 860-1 where SBFD intervals and non-SBFD intervals are each associated with a separate unified TCI state type. Accordingly, any given TCI codepoint may be mapped to a downlink TCI state, an uplink TCI state, both, or neither for non-SBFD intervals, and the same TCI codepoint may be mapped to a downlink TCI state, an uplink TCI state, both, or neither for SBFD intervals. For example, in the set of activated TCI codepoints 860-1, TCI codepoint 0 is mapped to a downlink TCI state and an uplink TCI state for non-SBFD intervals, and to a downlink TCI state and an uplink TCI state for SBFD intervals. Accordingly, the bitmap field associated with TCI codepoint 0 has the value “1111” to indicate that the TCI codepoint is mapped to a downlink TCI state for non-SBFD intervals, an uplink TCI state for non-SBFD intervals, a downlink TCI state for SBFD intervals, and an uplink TCI state for SBFD intervals. As further shown, in the set of activated TCI codepoints 860-1, TCI codepoint 1 is mapped to a downlink TCI state only for non-SBFD intervals, and to a downlink TCI state and an uplink TCI state for SBFD intervals. Accordingly, the bitmap field associated with TCI codepoint 1 has the value “1011” to indicate that the TCI codepoint is mapped to a downlink TCI state for non-SBFD intervals, not mapped to an uplink TCI state for non-SBFD intervals, mapped to a downlink TCI state for SBFD intervals, and mapped to an uplink TCI state for SBFD intervals.

In another example, FIG. 8E illustrates a set of activated TCI codepoints 860-2 where non-SBFD intervals are associated with a joint unified TCI state type and SBFD intervals are associated with a separate unified TCI state type. Accordingly, any given TCI codepoint may or may not be mapped to a joint TCI state for non-SBFD intervals, and the same TCI codepoint may be mapped to a downlink TCI state, an uplink TCI state, both, or neither for SBFD intervals. For example, in the set of activated TCI codepoints 860-2, TCI codepoints 0 and 1 are mapped to a joint TCI state for non-SBFD intervals, and to a downlink TCI state and an uplink TCI state for SBFD intervals. Accordingly, the bitmap field associated with TCI codepoints 0 and 1 has the value “111” to indicate that the TCI codepoint is mapped to a joint TCI state for non-SBFD intervals, a downlink TCI state for SBFD intervals, and an uplink TCI state for SBFD intervals. As further shown, in the set of activated TCI codepoints 860-2, TCI codepoint 2 is mapped only to a downlink TCI state and an uplink TCI state for SBFD intervals. Accordingly, the bitmap field associated with TCI codepoint 2 has the value “011” to indicate that the TCI codepoint is not mapped to a joint TCI state for non-SBFD intervals, mapped to a downlink TCI state for SBFD intervals, and mapped to an uplink TCI state for SBFD intervals. As further shown, in the set of activated TCI codepoints 860-2, TCI codepoint 3 is mapped only to a joint TCI state for non-SBFD intervals. Accordingly, the bitmap field associated with TCI codepoint 3 has the value “100” to indicate that the TCI codepoint is mapped to a joint TCI state for non-SBFD intervals, not mapped to a downlink TCI state for SBFD intervals, and not mapped to an uplink TCI state for SBFD intervals.

In some aspects, as described herein, when a TCI state activation MAC-CE activates multiple TCI codepoints and/or multiple TCI states under a unified TCI framework (for example, activating multiple beams associated with multiple uplink TCI states, downlink TCI states, and/or joint TCI states), the network node 110 may transmit, and the UE 120 may receive, a DCI message that includes a beam indication to indicate one of the multiple TCI codepoints or multiple TCI states to be used for communicating downlink channels, uplink channels, and/or reference signals in intervals associated with the appropriate duplex type. For example, in some aspects, the DCI message may include an explicit duplex indicator, where the DCI message includes a field to indicate one TCI codepoint (of the TCI codepoints activated by the TCI state activation MAC-CE) and a duplex type field that may have a first value to indicate that the corresponding TCI state (for example, a single uplink TCI state, a single downlink TCI state, or a single joint TCI state) is to be used for SBFD intervals or a second value to indicate that the corresponding TCI state is to be used for non-SBFD intervals.

Alternatively, in some aspects, the DCI message may indicate one TCI codepoint mapped to one or more TCI states, and a duplex type associated with the TCI codepoint may be identified according to a slot type associated with one or more slots, symbols, or other intervals for a data transmission scheduled by the DCI message (for example, in accordance with the DCI message scheduling a PDSCH or a PUSCH in an SBFD interval or a non-SBFD interval). Alternatively, in some aspects, the duplex type associated with the TCI codepoint may be identified according to a slot type associated with a slot in which the DCI message is transmitted by the network node 110 and received by the UE 120 (for example, in accordance with the DCI message being transmitted and received in an SBFD slot or a non-SBFD slot). Alternatively, in some aspects, the DCI message may indicate a first TCI codepoint for SBFD intervals and a second TCI codepoint for non-SBFD intervals, or a single TCI codepoint applied to SBFD and non-SBFD intervals. Furthermore, in cases where the TCI state activation MAC-CE does not include a duplex indicator in a payload, the DCI message may indicate a TCI codepoint associated with multiple TCI states, and may indicate one or more of the TCI states that are associated with SBFD intervals and one or more of the TCI states that are associated with non-SBFD intervals. In such cases, the UE 120 may implicitly apply the corresponding TCI state in intervals associated with the corresponding duplex type in accordance with an SBFD time configuration indication. Furthermore, the DCI message may include a bitmap (for example, with a similar design as shown in FIG. 8E and described above) to indicate the presence or absence of TCI states mapped to the TCI codepoint.

In some aspects, in cases where the UE 120 receives a DCI message (for example, a downlink DCI message associated with DCI format 1_1 or 1_2) indicating a TCI codepoint associated with one or more TCI states for SBFD intervals and/or non-SBFD intervals, the UE 120 may apply the SBFD-specific TCI states indicated in the DCI message in SBFD intervals and may apply the non-SBFD TCI states indicated in the DCI message in non-SBFD intervals. Furthermore, in cases where the DCI message indicates a TCI codepoint associated with one or more TCI states for SBFD intervals and one or more TCI states for non-SBFD intervals, the one or more TCI states associated with the non-SBFD intervals may be ordered before the one or more TCI states associated with the SBFD intervals in the DCI message.

FIG. 9 is a flowchart illustrating an example process 900 performed, for example, at a UE or an apparatus of a UE that supports communication using different duplex types in accordance with the present disclosure. Example process 900 is an example where the apparatus or the UE (for example, UE 120) performs operations associated with a unified TCI state for time intervals associated with different duplex types.

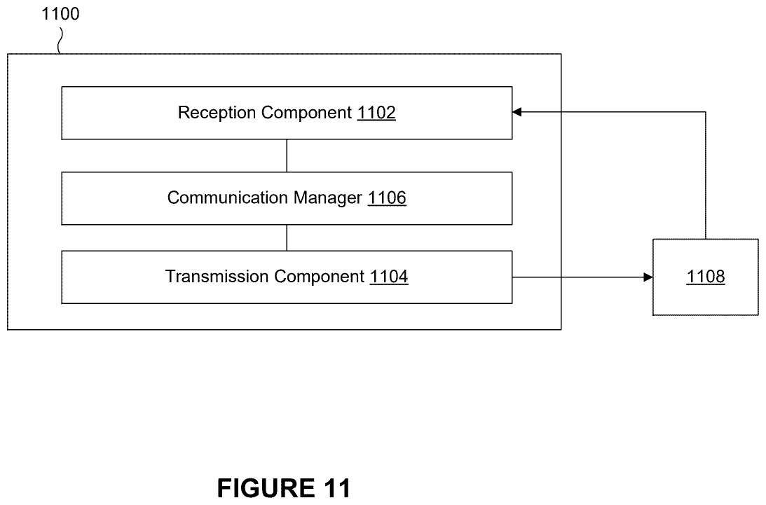

As shown in FIG. 9, in some aspects, process 900 may include receiving, from a network node, information that configures a unified TCI state type for one or more duplex types (block 910). For example, the UE (such as by using communication manager 140 or reception component 1102, depicted in FIG. 11) may receive, from a network node, information that configures a unified TCI state type for one or more duplex types, as described above.

As further shown in FIG. 9, in some aspects, process 900 may include receiving, from the network node, information that indicates one or more TCI states for communicating one or more of uplink channels, downlink channels, or reference signals in intervals associated with the one or more duplex types (block 920). For example, the UE (such as by using communication manager 140 or reception component 1102, depicted in FIG. 11) may receive, from the network node, information that indicates one or more TCI states for communicating one or more of uplink channels, downlink channels, or reference signals in intervals associated with the one or more duplex types, as described above.

As further shown in FIG. 9, in some aspects, process 900 may include communicating, with the network node in an interval associated with a duplex type, of the one or more duplex types, in accordance with the unified TCI state type and the one or more TCI states configured for the duplex type associated with the interval (block 930). For example, the UE (such as by using communication manager 140, reception component 1102, or transmission component 1104, depicted in FIG. 11) may communicate, with the network node in an interval associated with a duplex type, of the one or more duplex types, in accordance with the unified TCI state type and the one or more TCI states configured for the duplex type associated with the interval, as described above.

Process 900 may include additional aspects, such as any single aspect or any combination of aspects described below or in connection with one or more other processes described elsewhere herein.

In a first additional aspect, the information that configures the unified TCI state type indicates a separate or a joint unified TCI state type for intervals associated with an SBFD interval type, and a separate or a joint unified TCI state type for intervals associated with a non-SBFD interval type.

In a second additional aspect, alone or in combination with the first aspect, the intervals associated with the SBFD interval type and the intervals associated with the non-SBFD interval type are associated with a shared TCI state pool or separate TCI state pools.

In a third additional aspect, alone or in combination with one or more of the first and second aspects, the information that configures the unified TCI state type indicates a separate or a joint unified TCI state type for intervals associated with SBFD and non-SBFD interval types.

In a fourth additional aspect, alone or in combination with one or more of the first through third aspects, the information that indicates the one or more TCI states includes an RRC message that indicates a single TCI state, of the one or more TCI states, and at least one duplex type, of the one or more duplex types, associated with the single TCI state.

In a fifth additional aspect, alone or in combination with one or more of the first through fourth aspects, the single TCI state is an uplink TCI state, a downlink TCI state, or a joint TCI state associated with a unified TCI framework.

In a sixth additional aspect, alone or in combination with one or more of the first through fifth aspects, the RRC message includes a duplex type field to indicate the at least one duplex type associated with the single TCI state.

In a seventh additional aspect, alone or in combination with one or more of the first through sixth aspects, the RRC message omits a duplex type field to indicate that the single TCI state is associated with each of the one or more duplex types.

In an eighth additional aspect, alone or in combination with one or more of the first through seventh aspects, the information that indicates the one or more TCI states includes an RRC message that indicates multiple TCI states and at least one duplex type, of the one or more duplex types, associated with each respective TCI state.

In a ninth additional aspect, alone or in combination with one or more of the first through eighth aspects, the RRC message includes a duplex type field to indicate the at least one duplex type associated with a TCI state, of the multiple TCI states.

In a tenth additional aspect, alone or in combination with one or more of the first through ninth aspects, the RRC message omits a duplex type field to indicate that a TCI state, of the multiple TCI states, is associated with each of the one or more duplex types.

In an eleventh additional aspect, alone or in combination with one or more of the first through tenth aspects, the information that indicates the one or more TCI states includes an RRC message that configures multiple TCI states, a first MAC-CE that activates a first set of TCI codepoints that are each associated with one or more of the multiple TCI states and an SBFD interval type, and a second MAC-CE that activates a second set of TCI codepoints that are each associated with one or more of the multiple TCI states and a non-SBFD interval type.

In a twelfth additional aspect, alone or in combination with one or more of the first through eleventh aspects, the first MAC-CE includes a duplex type field associated with a first value to indicate that the first set of TCI codepoints is associated with the SBFD interval type and the second MAC-CE includes a duplex type field associated with a second value to indicate that the second set of TCI codepoints is associated with the non-SBFD interval type.

In a thirteenth additional aspect, alone or in combination with one or more of the first through twelfth aspects, the first set of TCI codepoints is associated with the SBFD interval type in accordance with the first MAC-CE being received in a first slot associated with an SBFD slot type, and the second set of TCI codepoints is associated with the non-SBFD interval type in accordance with the second MAC-CE being received in a second slot associated with a non-SBFD slot type.

In a fourteenth additional aspect, alone or in combination with one or more of the first through thirteenth aspects, the information that indicates the one or more TCI states includes an RRC message that configures multiple TCI states, and a MAC-CE that activates one or more TCI codepoints that are each associated with one or more of the multiple TCI states and a duplex type.

In a fifteenth additional aspect, alone or in combination with one or more of the first through fourteenth aspects, the MAC-CE includes one or more duplex type fields, associated with the one or more TCI codepoints, that each have a first value to indicate that a corresponding TCI codepoint is associated with an SBFD interval type or a second value to indicate that the corresponding TCI codepoint is associated with a non-SBFD interval type.

In a sixteenth additional aspect, alone or in combination with one or more of the first through fifteenth aspects, the information that indicates the one or more TCI states includes an RRC message that configures multiple TCI states, and a MAC-CE that activates one or more TCI codepoints that are each associated with one or more of the multiple TCI states for communicating in intervals associated with an SBFD interval type and one or more of the multiple TCI states for communicating in intervals associated with a non-SBFD interval type.

In a seventeenth additional aspect, alone or in combination with one or more of the first through sixteenth aspects, the one or more TCI codepoints are each associated with a bitmap that indicates whether a TCI state associated with a TCI state type and a duplex type is present in a TCI state indication field associated with the respective TCI codepoint.

In an eighteenth additional aspect, alone or in combination with one or more of the first through seventeenth aspects, the information that indicates the one or more TCI states includes a MAC-CE that activates multiple TCI codepoints that are each associated with one or more TCI states, and a DCI message that indicates one TCI codepoint, of the multiple TCI codepoints, and a duplex type associated with the one or more TCI states associated with the one TCI codepoint.

In a nineteenth additional aspect, alone or in combination with one or more of the first through eighteenth aspects, the information that indicates the one or more TCI states includes a MAC-CE that activates multiple TCI codepoints that are each associated with one or more TCI states, and a DCI message that indicates one TCI codepoint, of the multiple TCI codepoints, wherein a duplex type associated with the one or more TCI states associated with the one TCI codepoint corresponds to a duplex type associated with a slot or interval in which the DCI message schedules a data transmission or a slot or interval in which the DCI message is received.

In a twentieth additional aspect, alone or in combination with one or more of the first through nineteenth aspects, the information that indicates the one or more TCI states includes a MAC-CE that activates multiple TCI codepoints that are each associated with one or more TCI states, a DCI message that indicates a first TCI codepoint, of the multiple TCI codepoints, associated with one or more TCI states for intervals associated with an SBFD interval type and a second TCI codepoint, of the multiple TCI codepoints, associated with one or more TCI states for intervals associated with a non-SBFD interval type.

In a twenty-first additional aspect, alone or in combination with one or more of the first through twentieth aspects, the information that indicates the one or more TCI states includes a MAC-CE that activates multiple TCI codepoints that are each associated with one or more TCI states, and a DCI message that indicates a TCI codepoint, of the multiple TCI codepoints, associated with multiple TCI states, one or more of the multiple TCI states associated with an SBFD interval type, and one or more of the multiple TCI states associated with a non-SBFD interval type.

In a twenty-second additional aspect, alone or in combination with one or more of the first through twenty-first aspects, the information that indicates the one or more TCI states includes a DCI message that indicates a TCI codepoint associated with one or more TCI states for one or more of intervals associated with an SBFD interval type or intervals associated with a non-SBFD interval type.

In a twenty-third additional aspect, alone or in combination with one or more of the first through twenty-second aspects, the TCI codepoint is associated with a bitmap that indicates whether a TCI state associated with a TCI state type and a duplex type is present in a TCI state indication field associated with the TCI codepoint.

In a twenty-fourth additional aspect, alone or in combination with one or more of the first through twenty-third aspects, the TCI codepoint indicated in the DCI message is associated with one or more TCI states for intervals associated with the SBFD interval type and one or more TCI states for intervals associated with the non-SBFD, and the one or more TCI states for the intervals associated with the non-SBFD interval type are ordered before the one or more TCI states for the intervals associated with the SBFD interval type.

In a twenty-fifth additional aspect, alone or in combination with one or more of the first through twenty-fourth aspects, process 900 includes transmitting, to the network node, information indicating a capability to support different unified TCI states in intervals associated with different duplex types.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a flowchart illustrating an example process 1000 performed, for example, at a network node or an apparatus of a network node that supports communication using different duplex types in accordance with the present disclosure. Example process 1000 is an example where the apparatus or the network node (for example, network node 110) performs operations associated with a unified TCI state for time intervals associated with different duplex types.

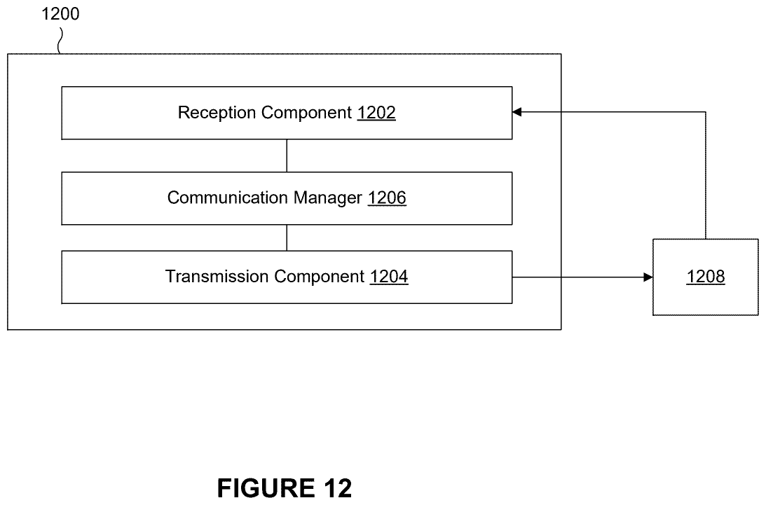

As shown in FIG. 10, in some aspects, process 1000 may include transmitting, to a UE, information that configures a unified TCI state type for one or more duplex types (block 1010). For example, the network node (such as by using communication manager 150 or transmission component 1204, depicted in FIG. 12) may transmit, to a UE, information that configures a unified TCI state type for one or more duplex types, as described above.

As further shown in FIG. 10, in some aspects, process 1000 may include transmitting, to the UE, information that indicates one or more TCI states for communicating one or more of uplink channels, downlink channels, or reference signals in intervals associated with the one or more duplex types (block 1020). For example, the network node (such as by using communication manager 150 or transmission component 1204, depicted in FIG. 12) may transmit, to the UE, information that indicates one or more TCI states for communicating one or more of uplink channels, downlink channels, or reference signals in intervals associated with the one or more duplex types, as described above.

As further shown in FIG. 10, in some aspects, process 1000 may include communicating, with the UE in an interval associated with a duplex type, of the one or more duplex types, in accordance with the unified TCI state type and the one or more TCI states configured for the duplex type associated with the interval (block 1030). For example, the network node (such as by using communication manager 150, reception component 1202, or transmission component 1204, depicted in FIG. 12) may communicate, with the UE in an interval associated with a duplex type, of the one or more duplex types, in accordance with the unified TCI state type and the one or more TCI states configured for the duplex type associated with the interval, as described above.

Process 1000 may include additional aspects, such as any single aspect or any combination of aspects described below or in connection with one or more other processes described elsewhere herein.

In a first additional aspect, the information that configures the unified TCI state type indicates a separate or a joint unified TCI state type for intervals associated with an SBFD interval type, and a separate or a joint unified TCI state type for intervals associated with a non-SBFD interval type.

In a second additional aspect, alone or in combination with the first aspect, the intervals associated with the SBFD interval type and the intervals associated with the non-SBFD interval type are associated with a shared TCI state pool or separate TCI state pools.

In a third additional aspect, alone or in combination with one or more of the first and second aspects, the information that configures the unified TCI state type indicates a separate or a joint unified TCI state type for intervals associated with SBFD and non-SBFD interval types.

In a fourth additional aspect, alone or in combination with one or more of the first through third aspects, the information that indicates the one or more TCI states includes an RRC message that indicates a single TCI state, of the one or more TCI states, and at least one duplex type, of the one or more duplex types, associated with the single TCI state.

In a fifth additional aspect, alone or in combination with one or more of the first through fourth aspects, the single TCI state is an uplink TCI state, a downlink TCI state, or a joint TCI state associated with a unified TCI framework.

In a sixth additional aspect, alone or in combination with one or more of the first through fifth aspects, the RRC message includes a duplex type field to indicate the at least one duplex type associated with the single TCI state.

In a seventh additional aspect, alone or in combination with one or more of the first through sixth aspects, the RRC message omits a duplex type field to indicate that the single TCI state is associated with each of the one or more duplex types.

In an eighth additional aspect, alone or in combination with one or more of the first through seventh aspects, the information that indicates the one or more TCI states includes an RRC message that indicates multiple TCI states and at least one duplex type, of the one or more duplex types, associated with each respective TCI state.

In a ninth additional aspect, alone or in combination with one or more of the first through eighth aspects, the RRC message includes a duplex type field to indicate the at least one duplex type associated with a TCI state, of the multiple TCI states.

In a tenth additional aspect, alone or in combination with one or more of the first through ninth aspects, the RRC message omits a duplex type field to indicate that a TCI state, of the multiple TCI states, is associated with each of the one or more duplex types.

In an eleventh additional aspect, alone or in combination with one or more of the first through tenth aspects, the information that indicates the one or more TCI states includes an RRC message that configures multiple TCI states, a first MAC-CE that activates a first set of TCI codepoints that are each associated with one or more of the multiple TCI states and an SBFD interval type, and a second MAC-CE that activates a second set of TCI codepoints that are each associated with one or more of the multiple TCI states and a non-SBFD interval type.

In a twelfth additional aspect, alone or in combination with one or more of the first through eleventh aspects, the first MAC-CE includes a duplex type field associated with a first value to indicate that the first set of TCI codepoints is associated with the SBFD interval type and the second MAC-CE includes a duplex type field associated with a second value to indicate that the second set of TCI codepoints is associated with the non-SBFD interval type.

In a thirteenth additional aspect, alone or in combination with one or more of the first through twelfth aspects, the first set of TCI codepoints is associated with the SBFD interval type in accordance with the first MAC-CE being transmitted in a first slot associated with an SBFD slot type, and the second set of TCI codepoints is associated with the non-SBFD interval type in accordance with the second MAC-CE being transmitted in a second slot associated with a non-SBFD slot type.

In a fourteenth additional aspect, alone or in combination with one or more of the first through thirteenth aspects, the information that indicates the one or more TCI states includes an RRC message that configures multiple TCI states, and a MAC-CE that activates one or more TCI codepoints that are each associated with one or more of the multiple TCI states and a duplex type.

In a fifteenth additional aspect, alone or in combination with one or more of the first through fourteenth aspects, the MAC-CE includes one or more duplex type fields, associated with the one or more TCI codepoints, that each have a first value to indicate that a corresponding TCI codepoint is associated with an SBFD interval type or a second value to indicate that the corresponding TCI codepoint is associated with a non-SBFD interval type.

In a sixteenth additional aspect, alone or in combination with one or more of the first through fifteenth aspects, the information that indicates the one or more TCI states includes an RRC message that configures multiple TCI states, and a MAC-CE that activates one or more TCI codepoints that are each associated with one or more of the multiple TCI states for communicating in intervals associated with an SBFD interval type and one or more of the multiple TCI states for communicating in intervals associated with a non-SBFD interval type.

In a seventeenth additional aspect, alone or in combination with one or more of the first through sixteenth aspects, the one or more TCI codepoints are each associated with a bitmap that indicates whether a TCI state associated with a TCI state type and a duplex type is present in a TCI state indication field associated with the respective TCI codepoint.

In an eighteenth additional aspect, alone or in combination with one or more of the first through seventeenth aspects, the information that indicates the one or more TCI states includes a MAC-CE that activates multiple TCI codepoints that are each associated with one or more TCI states, and a DCI message that indicates one TCI codepoint, of the multiple TCI codepoints, and a duplex type associated with the one or more TCI states associated with the one TCI codepoint.

In a nineteenth additional aspect, alone or in combination with one or more of the first through eighteenth aspects, the information that indicates the one or more TCI states includes a MAC-CE that activates multiple TCI codepoints that are each associated with one or more TCI states, and a DCI message that indicates one TCI codepoint, of the multiple TCI codepoints, wherein a duplex type associated with the one or more TCI states associated with the one TCI codepoint corresponds to a duplex type associated with a slot or interval in which the DCI message schedules a data transmission or a slot or interval in which the DCI message is transmitted.

In a twentieth additional aspect, alone or in combination with one or more of the first through nineteenth aspects, the information that indicates the one or more TCI states includes a MAC-CE that activates multiple TCI codepoints that are each associated with one or more TCI states, a DCI message that indicates a first TCI codepoint, of the multiple TCI codepoints, associated with one or more TCI states for intervals associated with an SBFD interval type and a second TCI codepoint, of the multiple TCI codepoints, associated with one or more TCI states for intervals associated with a non-SBFD interval type.

In a twenty-first additional aspect, alone or in combination with one or more of the first through twentieth aspects, the information that indicates the one or more TCI states includes a MAC-CE that activates multiple TCI codepoints that are each associated with one or more TCI states, and a DCI message that indicates a TCI codepoint, of the multiple TCI codepoints, associated with multiple TCI states, one or more of the multiple TCI states associated with an SBFD interval type, and one or more of the multiple TCI states associated with a non-SBFD interval type.

In a twenty-second additional aspect, alone or in combination with one or more of the first through twenty-first aspects, the information that indicates the one or more TCI states includes a DCI message that indicates a TCI codepoint associated with one or more TCI states for one or more of intervals associated with an SBFD interval type or intervals associated with a non-SBFD interval type.

In a twenty-third additional aspect, alone or in combination with one or more of the first through twenty-second aspects, the TCI codepoint is associated with a bitmap that indicates whether a TCI state associated with a TCI state type and a duplex type is present in a TCI state indication field associated with the TCI codepoint.

In a twenty-fourth additional aspect, alone or in combination with one or more of the first through twenty-third aspects, the TCI codepoint indicated in the DCI message is associated with one or more TCI states for intervals associated with the SBFD interval type and one or more TCI states for intervals associated with the non-SBFD, and the one or more TCI states for the intervals associated with the non-SBFD interval type are ordered before the one or more TCI states for the intervals associated with the SBFD interval type.

In a twenty-fifth additional aspect, alone or in combination with one or more of the first through twenty-fourth aspects, process 1000 includes receiving, from the UE, information indicating a capability to support different unified TCI states in intervals associated with different duplex types.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a diagram of an example apparatus 1100 for wireless communication that supports a unified TCI state for intervals associated with different duplex types in accordance with the present disclosure. The apparatus 1100 may be a UE, or a UE may include the apparatus 1100. In some aspects, the apparatus 1100 includes a reception component 1102, a transmission component 1104, and a communication manager 140, which may be in communication with one another (for example, via one or more buses). As shown, the apparatus 1100 may communicate with another apparatus 1108 (such as a UE, a network node, or another wireless communication device) using the reception component 1102 and the transmission component 1104.

In some aspects, the apparatus 1100 may be configured to and/or operable to perform one or more operations described herein in connection with FIGS. 8A-8E. Additionally or alternatively, the apparatus 1100 may be configured to and/or operable to perform one or more processes described herein, such as process 900 of FIG. 9. In some aspects, the apparatus 1100 may include one or more components of the UE described above in connection with FIG. 1 and FIG. 2.

The reception component 1102 may receive communications, such as reference signals, control information, and/or data communications, from the apparatus 1108. The reception component 1102 may provide received communications to one or more other components of the apparatus 1100, such as the communication manager 140. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1102 may include one or more antennas, one or more modems, one or more demodulators, one or more MIMO detectors, one or more receive processors, one or more controllers/processors, and/or one or more memories of the UE described above in connection with FIG. 1 and FIG. 2.

The transmission component 1104 may transmit communications, such as reference signals, control information, and/or data communications, to the apparatus 1108. In some aspects, the communication manager 140 may generate communications and may transmit the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, and/or one or more memories of the UE described above in connection with FIG. 1 and FIG. 2. In some aspects, the transmission component 1104 may be co-located with the reception component 1102 in one or more transceivers.

The communication manager 140 may receive or may cause the reception component 1102 to receive, from a network node, information that configures a unified TCI state type for one or more duplex types. The communication manager 140 may receive or may cause the reception component 1102 to receive, from the network node, information that indicates one or more TCI states for communicating one or more of uplink channels, downlink channels, or reference signals in intervals associated with the one or more duplex types. The communication manager 140 may communicate, with the network node in an interval associated with a duplex type, of the one or more duplex types, in accordance with the unified TCI state type and the one or more TCI states configured for the duplex type associated with the interval. In some aspects, the communication manager 140 may perform one or more operations described elsewhere herein as being performed by one or more components of the communication manager 140.

The communication manager 140 may include one or more controllers/processors and/or one or more memories of the UE described above in connection with FIG. 1 and FIG. 2. In some aspects, the communication manager 140 includes a set of components. Alternatively, the set of components may be separate and distinct from the communication manager 140. In some aspects, one or more components of the set of components may include or may be implemented within one or more controllers/processors and/or one or more memories of the UE described above in connection with FIG. 1 and FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive, from a network node, information that configures a unified TCI state type for one or more duplex types. The reception component 1102 may receive, from the network node, information that indicates one or more TCI states for communicating one or more of uplink channels, downlink channels, or reference signals in intervals associated with the one or more duplex types. The reception component 1102 and/or the transmission component 1104 may communicate, with the network node in an interval associated with a duplex type, of the one or more duplex types, in accordance with the unified TCI state type and the one or more TCI states configured for the duplex type associated with the interval.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

FIG. 12 is a diagram of an example apparatus 1200 for wireless communication that supports a unified TCI state for time intervals associated with different duplex types in accordance with the present disclosure. The apparatus 1200 may be a network node, or a network node may include the apparatus 1200. In some aspects, the apparatus 1200 includes a reception component 1202, a transmission component 1204, and a communication manager 150, which may be in communication with one another (for example, via one or more buses). As shown, the apparatus 1200 may communicate with another apparatus 1208 (such as a UE, a network node, or another wireless communication device) using the reception component 1202 and the transmission component 1204.

In some aspects, the apparatus 1200 may be configured to and/or operable to perform one or more operations described herein in connection with FIGS. 8A-8E. Additionally or alternatively, the apparatus 1200 may be configured to and/or operable to perform one or more processes described herein, such as process 1000 of FIG. 10. In some aspects, the apparatus 1200 may include one or more components of the network node described above in connection with FIG. 1 and FIG. 2.

The reception component 1202 may receive communications, such as reference signals, control information, and/or data communications, from the apparatus 1208. The reception component 1202 may provide received communications to one or more other components of the apparatus 1200, such as the communication manager 150. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1202 may include one or more antennas, one or more modems, one or more demodulators, one or more MIMO detectors, one or more receive processors, one or more controllers/processors, and/or one or more memories of the network node described above in connection with FIG. 1 and FIG. 2.

The transmission component 1204 may transmit communications, such as reference signals, control information, and/or data communications, to the apparatus 1208. In some aspects, the communication manager 150 may generate communications and may transmit the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, and/or one or more memories of the network node described above in connection with FIG. 1 and FIG. 2. In some aspects, the transmission component 1204 may be co-located with the reception component 1202 in one or more transceivers.

The communication manager 150 may transmit or may cause the transmission component 1204 to transmit, to a UE, information that configures a unified TCI state type for one or more duplex types. The communication manager 150 may transmit or may cause the transmission component 1204 to transmit, to the UE, information that indicates one or more TCI states for communicating one or more of uplink channels, downlink channels, or reference signals in intervals associated with the one or more duplex types. The communication manager 150 may communicate, with the UE in an interval associated with a duplex type, of the one or more duplex types, in accordance with the unified TCI state type and the one or more TCI states configured for the duplex type associated with the interval. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node described above in connection with FIG. 1 and FIG. 2. In some aspects, the communication manager 150 includes a set of components. Alternatively, the set of components may be separate and distinct from the communication manager 150. In some aspects, one or more components of the set of components may include or may be implemented within one or more controllers/processors, one or more memories, one or more schedulers, and/or one or more communication units of the network node described above in connection with FIG. 1 and FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The transmission component 1204 may transmit, to a UE, information that configures a unified TCI state type for one or more duplex types. The transmission component 1204 may transmit, to the UE, information that indicates one or more TCI states for communicating one or more of uplink channels, downlink channels, or reference signals in intervals associated with the one or more duplex types. The reception component 1202 and/or the transmission component 1204 may communicate, with the UE in an interval associated with a duplex type, of the one or more duplex types, in accordance with the unified TCI state type and the one or more TCI states configured for the duplex type associated with the interval.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed at a UE, comprising: receiving, from a network node, information that configures a unified TCI state type for one or more duplex types; receiving, from the network node, information that indicates one or more TCI states for communicating one or more of uplink channels, downlink channels, or reference signals in intervals associated with the one or more duplex types; and communicating, with the network node in an interval associated with a duplex type, of the one or more duplex types, in accordance with the unified TCI state type and the one or more TCI states configured for the duplex type associated with the interval.

Aspect 2: The method of Aspect 1, wherein the information that configures the unified TCI state type indicates a separate or a joint unified TCI state type for intervals associated with an SBFD interval type, and a separate or a joint unified TCI state type for intervals associated with a non-SBFD interval type.

Aspect 3: The method of Aspect 2, wherein the intervals associated with the SBFD interval type and the intervals associated with the non-SBFD interval type are associated with a shared TCI state pool or separate TCI state pools.

Aspect 4: The method of any of Aspects 1-3, wherein the information that configures the unified TCI state type indicates a separate or a joint unified TCI state type for intervals associated with SBFD and non-SBFD interval types.

Aspect 5: The method of any of Aspects 1-4, wherein the information that indicates the one or more TCI states includes an RRC message that indicates a single TCI state, of the one or more TCI states, and at least one duplex type, of the one or more duplex types, associated with the single TCI state.

Aspect 6: The method of Aspect 5, wherein the single TCI state is an uplink TCI state, a downlink TCI state, or a joint TCI state associated with a unified TCI framework.

Aspect 7: The method of Aspect 5, wherein the RRC message includes a duplex type field to indicate the at least one duplex type associated with the single TCI state.

Aspect 8: The method of Aspect 5, wherein the RRC message omits a duplex type field to indicate that the single TCI state is associated with each of the one or more duplex types.

Aspect 9: The method of any of Aspects 1-8, wherein the information that indicates the one or more TCI states includes an RRC message that indicates multiple TCI states and at least one duplex type, of the one or more duplex types, associated with each respective TCI state.

Aspect 10: The method of Aspect 9, wherein the RRC message includes a duplex type field to indicate the at least one duplex type associated with a TCI state, of the multiple TCI states.

Aspect 11: The method of Aspect 9, wherein the RRC message omits a duplex type field to indicate that a TCI state, of the multiple TCI states, is associated with each of the one or more duplex types.

Aspect 12: The method of any of Aspects 1-11, wherein the information that indicates the one or more TCI states includes: an RRC message that configures multiple TCI states, a first MAC-CE that activates a first set of TCI codepoints that are each associated with one or more of the multiple TCI states and an SBFD interval type, and a second MAC-CE that activates a second set of TCI codepoints that are each associated with one or more of the multiple TCI states and a non-SBFD interval type.

Aspect 13: The method of Aspect 12, wherein the first MAC-CE includes a duplex type field associated with a first value to indicate that the first set of TCI codepoints is associated with the SBFD interval type and the second MAC-CE includes a duplex type field associated with a second value to indicate that the second set of TCI codepoints is associated with the non-SBFD interval type.

Aspect 14: The method of Aspect 12, wherein the first set of TCI codepoints is associated with the SBFD interval type in accordance with the first MAC-CE being received in a first slot associated with an SBFD slot type, and the second set of TCI codepoints is associated with the non-SBFD interval type in accordance with the second MAC-CE being received in a second slot associated with a non-SBFD slot type.

Aspect 15: The method of any of Aspects 1-14, wherein the information that indicates the one or more TCI states includes: an RRC message that configures multiple TCI states, and a MAC-CE that activates one or more TCI codepoints that are each associated with one or more of the multiple TCI states and a duplex type.

Aspect 16: The method of Aspect 15, wherein the MAC-CE includes one or more duplex type fields, associated with the one or more TCI codepoints, that each have a first value to indicate that a corresponding TCI codepoint is associated with an SBFD interval type or a second value to indicate that the corresponding TCI codepoint is associated with a non-SBFD interval type.

Aspect 17: The method of any of Aspects 1-16, wherein the information that indicates the one or more TCI states includes: an RRC message that configures multiple TCI states, and a MAC-CE that activates one or more TCI codepoints that are each associated with one or more of the multiple TCI states for communicating in intervals associated with an SBFD interval type and one or more of the multiple TCI states for communicating in intervals associated with a non-SBFD interval type.

Aspect 18: The method of Aspect 17, wherein the one or more TCI codepoints are each associated with a bitmap that indicates whether a TCI state associated with a TCI state type and a duplex type is present in a TCI state indication field associated with the respective TCI codepoint.

Aspect 19: The method of any of Aspects 1-18, wherein the information that indicates the one or more TCI states includes: a MAC-CE that activates multiple TCI codepoints that are each associated with one or more TCI states, and a DCI message that indicates one TCI codepoint, of the multiple TCI codepoints, and a duplex type associated with the one or more TCI states associated with the one TCI codepoint.

Aspect 20: The method of any of Aspects 1-19, wherein the information that indicates the one or more TCI states includes: a MAC-CE that activates multiple TCI codepoints that are each associated with one or more TCI states, and a DCI message that indicates one TCI codepoint, of the multiple TCI codepoints, wherein a duplex type associated with the one or more TCI states associated with the one TCI codepoint corresponds to a duplex type associated with a slot or interval in which the DCI message schedules a data transmission or a slot or interval in which the DCI message is received.

Aspect 21: The method of any of Aspects 1-20, wherein the information that indicates the one or more TCI states includes: a MAC-CE that activates multiple TCI codepoints that are each associated with one or more TCI states, a DCI message that indicates a first TCI codepoint, of the multiple TCI codepoints, associated with one or more TCI states for intervals associated with an SBFD interval type and a second TCI codepoint, of the multiple TCI codepoints, associated with one or more TCI states for intervals associated with a non-SBFD interval type.

Aspect 22: The method of any of Aspects 1-21, wherein the information that indicates the one or more TCI states includes: a MAC-CE that activates multiple TCI codepoints that are each associated with one or more TCI states, and a DCI message that indicates a TCI codepoint, of the multiple TCI codepoints, associated with multiple TCI states, one or more of the multiple TCI states associated with an SBFD interval type, and one or more of the multiple TCI states associated with a non-SBFD interval type.

Aspect 23: The method of any of Aspects 1-22, wherein the information that indicates the one or more TCI states includes a DCI message that indicates a TCI codepoint associated with one or more TCI states for one or more of intervals associated with an SBFD interval type or intervals associated with a non-SBFD interval type.

Aspect 24: The method of Aspect 23, wherein the TCI codepoint is associated with a bitmap that indicates whether a TCI state associated with a TCI state type and a duplex type is present in a TCI state indication field associated with the TCI codepoint.

Aspect 25: The method of Aspect 23, wherein the TCI codepoint indicated in the DCI message is associated with one or more TCI states for intervals associated with the SBFD interval type and one or more TCI states for intervals associated with the non-SBFD, and wherein the one or more TCI states for the intervals associated with the non-SBFD interval type are ordered before the one or more TCI states for the intervals associated with the SBFD interval type.

Aspect 26: The method of any of Aspects 1-25, further comprising: transmitting, to the network node, information indicating a capability to support different unified TCI states in intervals associated with different duplex types.

Aspect 27: A method of wireless communication performed at a network node, comprising: transmitting, to a UE, information that configures a unified TCI state type for one or more duplex types; transmitting, to the UE, information that indicates one or more TCI states for communicating one or more of uplink channels, downlink channels, or reference signals in intervals associated with the one or more duplex types; and communicating, with the UE in an interval associated with a duplex type, of the one or more duplex types, in accordance with the unified TCI state type and the one or more TCI states configured for the duplex type associated with the interval.

Aspect 28: The method of Aspect 27, wherein the information that configures the unified TCI state type indicates a separate or a joint unified TCI state type for intervals associated with an SBFD interval type, and a separate or a joint unified TCI state type for intervals associated with a non-SBFD interval type.

Aspect 29: The method of Aspect 28, wherein the intervals associated with the SBFD interval type and the intervals associated with the non-SBFD interval type are associated with a shared TCI state pool or separate TCI state pools.

Aspect 30: The method of any of Aspects 27-29, wherein the information that configures the unified TCI state type indicates a separate or a joint unified TCI state type for intervals associated with SBFD and non-SBFD interval types.

Aspect 31: The method of any of Aspects 27-30, wherein the information that indicates the one or more TCI states includes an RRC message that indicates a single TCI state, of the one or more TCI states, and at least one duplex type, of the one or more duplex types, associated with the single TCI state.

Aspect 32: The method of Aspect 31, wherein the single TCI state is an uplink TCI state, a downlink TCI state, or a joint TCI state associated with a unified TCI framework.

Aspect 33: The method of Aspect 31, wherein the RRC message includes a duplex type field to indicate the at least one duplex type associated with the single TCI state.

Aspect 34: The method of Aspect 31, wherein the RRC message omits a duplex type field to indicate that the single TCI state is associated with each of the one or more duplex types.

Aspect 35: The method of any of Aspects 27-34, wherein the information that indicates the one or more TCI states includes an RRC message that indicates multiple TCI states and at least one duplex type, of the one or more duplex types, associated with each respective TCI state.

Aspect 36: The method of Aspect 35, wherein the RRC message includes a duplex type field to indicate the at least one duplex type associated with a TCI state, of the multiple TCI states.

Aspect 37: The method of Aspect 35, wherein the RRC message omits a duplex type field to indicate that a TCI state, of the multiple TCI states, is associated with each of the one or more duplex types.

Aspect 38: The method of any of Aspects 27-37, wherein the information that indicates the one or more TCI states includes: an RRC message that configures multiple TCI states, a first MAC-CE that activates a first set of TCI codepoints that are each associated with one or more of the multiple TCI states and an SBFD interval type, and a second MAC-CE that activates a second set of TCI codepoints that are each associated with one or more of the multiple TCI states and a non-SBFD interval type.

Aspect 39: The method of Aspect 38, wherein the first MAC-CE includes a duplex type field associated with a first value to indicate that the first set of TCI codepoints is associated with the SBFD interval type and the second MAC-CE includes a duplex type field associated with a second value to indicate that the second set of TCI codepoints is associated with the non-SBFD interval type.

Aspect 40: The method of Aspect 38, wherein the first set of TCI codepoints is associated with the SBFD interval type in accordance with the first MAC-CE being transmitted in a first slot associated with an SBFD slot type, and the second set of TCI codepoints is associated with the non-SBFD interval type in accordance with the second MAC-CE being transmitted in a second slot associated with a non-SBFD slot type.

Aspect 41: The method of any of Aspects 27-40, wherein the information that indicates the one or more TCI states includes: an RRC message that configures multiple TCI states, and a MAC-CE that activates one or more TCI codepoints that are each associated with one or more of the multiple TCI states and a duplex type.

Aspect 42: The method of Aspect 41, wherein the MAC-CE includes one or more duplex type fields, associated with the one or more TCI codepoints, that each have a first value to indicate that a corresponding TCI codepoint is associated with an SBFD interval type or a second value to indicate that the corresponding TCI codepoint is associated with a non-SBFD interval type.

Aspect 43: The method of any of Aspects 27-42, wherein the information that indicates the one or more TCI states includes: an RRC message that configures multiple TCI states, and a MAC-CE that activates one or more TCI codepoints that are each associated with one or more of the multiple TCI states for communicating in intervals associated with an SBFD interval type and one or more of the multiple TCI states for communicating in intervals associated with a non-SBFD interval type.

Aspect 44: The method of Aspect 43, wherein the one or more TCI codepoints are each associated with a bitmap that indicates whether a TCI state associated with a TCI state type and a duplex type is present in a TCI state indication field associated with the respective TCI codepoint.

Aspect 45: The method of any of Aspects 27-44, wherein the information that indicates the one or more TCI states includes: a MAC-CE that activates multiple TCI codepoints that are each associated with one or more TCI states, and a DCI message that indicates one TCI codepoint, of the multiple TCI codepoints, and a duplex type associated with the one or more TCI states associated with the one TCI codepoint.

Aspect 46: The method of any of Aspects 27-45, wherein the information that indicates the one or more TCI states includes: a MAC-CE that activates multiple TCI codepoints that are each associated with one or more TCI states, and a DCI message that indicates one TCI codepoint, of the multiple TCI codepoints, wherein a duplex type associated with the one or more TCI states associated with the one TCI codepoint corresponds to a duplex type associated with a slot or interval in which the DCI message schedules a data transmission or a slot or interval in which the DCI message is transmitted.

Aspect 47: The method of any of Aspects 27-46, wherein the information that indicates the one or more TCI states includes: a MAC-CE that activates multiple TCI codepoints that are each associated with one or more TCI states, a DCI message that indicates a first TCI codepoint, of the multiple TCI codepoints, associated with one or more TCI states for intervals associated with an SBFD interval type and a second TCI codepoint, of the multiple TCI codepoints, associated with one or more TCI states for intervals associated with a non-SBFD interval type.

Aspect 48: The method of any of Aspects 27-47, wherein the information that indicates the one or more TCI states includes: a MAC-CE that activates multiple TCI codepoints that are each associated with one or more TCI states, and a DCI message that indicates a TCI codepoint, of the multiple TCI codepoints, associated with multiple TCI states, one or more of the multiple TCI states associated with an SBFD interval type, and one or more of the multiple TCI states associated with a non-SBFD interval type.

Aspect 49: The method of any of Aspects 27-48, wherein the information that indicates the one or more TCI states includes a DCI message that indicates a TCI codepoint associated with one or more TCI states for one or more of intervals associated with an SBFD interval type or intervals associated with a non-SBFD interval type.

Aspect 50: The method of Aspect 49, wherein the TCI codepoint is associated with a bitmap that indicates whether a TCI state associated with a TCI state type and a duplex type is present in a TCI state indication field associated with the TCI codepoint.

Aspect 51: The method of Aspect 49, wherein the TCI codepoint indicated in the DCI message is associated with one or more TCI states for intervals associated with the SBFD interval type and one or more TCI states for intervals associated with the non-SBFD, and wherein the one or more TCI states for the intervals associated with the non-SBFD interval type are ordered before the one or more TCI states for the intervals associated with the SBFD interval type.

Aspect 52: The method of any of Aspects 27-51, further comprising: receiving, from the UE, information indicating a capability to support different unified TCI states in intervals associated with different duplex types.

Aspect 53: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-52.

Aspect 54: An apparatus for wireless communication at a device, the apparatus comprising one or more memories and one or more processors coupled to the one or more memories, the one or more processors configured to cause the device to perform the method of one or more of Aspects 1-52.

Aspect 55: An apparatus for wireless communication, the apparatus comprising at least one means for performing the method of one or more of Aspects 1-52.

Aspect 56: A non-transitory computer-readable medium storing code for wireless communication, the code comprising instructions executable by one or more processors to perform the method of one or more of Aspects 1-52.

Aspect 57: A non-transitory computer-readable medium storing a set of instructions for wireless communication, the set of instructions comprising one or more instructions that, when executed by one or more processors of a device, cause the device to perform the method of one or more of Aspects 1-52.

Aspect 58: A device for wireless communication, the device comprising a processing system that includes one or more processors and one or more memories coupled with the one or more processors, the processing system configured to cause the device to perform the method of one or more of Aspects 1-52.

Aspect 59: An apparatus for wireless communication at a device, the apparatus comprising one or more memories and one or more processors coupled to the one or more memories, the one or more processors individually or collectively configured to cause the device to perform the method of one or more of Aspects 1-52.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), identifying, inferring, ascertaining, measuring, and the like. Also, “determining” can include receiving (such as receiving information or receiving an indication), accessing (such as accessing data stored in memory), transmitting (such as transmitting information) and the like. Also, “determining” can include resolving, selecting, obtaining, choosing, establishing and other such similar actions. The term “identify” or “identifying” also encompasses a wide variety of actions and, therefore, “identifying” can include calculating, computing, processing, deriving, investigating, looking up (such as via looking up in a table, a database or another data structure), inferring, ascertaining, measuring, and the like. Also, “identifying” can include receiving (such as receiving information or receiving an indication), accessing (such as accessing data stored in memory), transmitting (such as transmitting information) and the like. Also, “identifying” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, as used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories storing processor-executable code; and
one or more processors coupled with the one or more memories, at least one processor of the one or more processors configured to cause the apparatus to:
receive, from a network node, information that configures a unified transmission configuration indication (TCI) state type for one or more duplex types;
receive, from the network node, information that indicates one or more TCI states for communicating one or more of uplink channels, downlink channels, or reference signals in intervals associated with the one or more duplex types; and
communicate, with the network node in an interval associated with a duplex type, of the one or more duplex types, in accordance with the unified TCI state type and the one or more TCI states configured for the duplex type associated with the interval.

2. The apparatus of claim 1, wherein the information that configures the unified TCI state type indicates a separate or a joint unified TCI state type for intervals associated with a sub-band full-duplex (SBFD) interval type, and a separate or a joint unified TCI state type for intervals associated with a non-SBFD interval type.

3. The apparatus of claim 2, wherein the intervals associated with the SBFD interval type and the intervals associated with the non-SBFD interval type are associated with a shared TCI state pool or separate TCI state pools.

4. The apparatus of claim 1, wherein the information that configures the unified TCI state type indicates a separate or a joint unified TCI state type for intervals associated with sub-band full-duplex (SBFD) and non-SBFD interval types.

5. The apparatus of claim 1, wherein the information that indicates the one or more TCI states includes a radio resource control (RRC) message that indicates a single TCI state, of the one or more TCI states, and at least one duplex type, of the one or more duplex types, associated with the single TCI state.

6. The apparatus of claim 1, wherein the information that indicates the one or more TCI states includes a radio resource control (RRC) message that indicates multiple TCI states and at least one duplex type, of the one or more duplex types, associated with each respective TCI state.

7. The apparatus of claim 1, wherein the information that indicates the one or more TCI states includes:
a radio resource control (RRC) message that configures multiple TCI states,
a first medium access control (MAC) control element (MAC-CE) that activates a first set of TCI codepoints that are each associated with one or more of the multiple TCI states and a sub-band full-duplex (SBFD) interval type, and
a second MAC-CE that activates a second set of TCI codepoints that are each associated with one or more of the multiple TCI states and a non-SBFD interval type.

8. The apparatus of claim 7, wherein the first MAC-CE includes a duplex type field associated with a first value to indicate that the first set of TCI codepoints is associated with the SBFD interval type and the second MAC-CE includes a duplex type field associated with a second value to indicate that the second set of TCI codepoints is associated with the non-SBFD interval type.

9. The apparatus of claim 7, wherein the first set of TCI codepoints is associated with the SBFD interval type in accordance with the first MAC-CE being received in a first slot associated with an SBFD slot type, and the second set of TCI codepoints is associated with the non-SBFD interval type in accordance with the second MAC-CE being received in a second slot associated with a non-SBFD slot type.

10. The apparatus of claim 1, wherein the information that indicates the one or more TCI states includes:
a radio resource control (RRC) message that configures multiple TCI states, and
a medium access control (MAC) control element (MAC-CE) that activates one or more TCI codepoints that are each associated with one or more of the multiple TCI states and a duplex type.

11. The apparatus of claim 1, wherein the information that indicates the one or more TCI states includes:
a radio resource control (RRC) message that configures multiple TCI states, and
a medium access control (MAC) control element (MAC-CE) that activates one or more TCI codepoints that are each associated with one or more of the multiple TCI states for communicating in intervals associated with a sub-band full-duplex (SBFD) interval type and one or more of the multiple TCI states for communicating in intervals associated with a non-SBFD interval type.

12. The apparatus of claim 11, wherein the one or more TCI codepoints are each associated with a bitmap that indicates whether a TCI state associated with a TCI state type and a duplex type is present in a TCI state indication field associated with the respective TCI codepoint.

13. The apparatus of claim 1, wherein the information that indicates the one or more TCI states includes:
a medium access control (MAC) control element (MAC-CE) that activates multiple TCI codepoints that are each associated with one or more TCI states, and
a downlink control information (DCI) message that indicates one TCI codepoint, of the multiple TCI codepoints, and a duplex type associated with the one or more TCI states associated with the one TCI codepoint.

14. The apparatus of claim 1, wherein the information that indicates the one or more TCI states includes:
a medium access control (MAC) control element (MAC-CE) that activates multiple TCI codepoints that are each associated with one or more TCI states, and
a downlink control information (DCI) message that indicates one TCI codepoint, of the multiple TCI codepoints, wherein a duplex type associated with the one or more TCI states associated with the one TCI codepoint corresponds to a duplex type associated with a slot or interval in which the DCI message schedules a data transmission or a slot or interval in which the DCI message is received.

15. The apparatus of claim 1, wherein the information that indicates the one or more TCI states includes:
a medium access control (MAC) control element (MAC-CE) that activates multiple TCI codepoints that are each associated with one or more TCI states,
a downlink control information (DCI) message that indicates a first TCI codepoint, of the multiple TCI codepoints, associated with one or more TCI states for intervals associated with a sub-band full-duplex (SBFD) interval type and a second TCI codepoint, of the multiple TCI codepoints, associated with one or more TCI states for intervals associated with a non-SBFD interval type.

16. The apparatus of claim 1, wherein the information that indicates the one or more TCI states includes:
a medium access control (MAC) control element (MAC-CE) that activates multiple TCI codepoints that are each associated with one or more TCI states, and
a downlink control information (DCI) message that indicates a TCI codepoint, of the multiple TCI codepoints, associated with multiple TCI states, one or more of the multiple TCI states associated with a sub-band full-duplex (SBFD) interval type, and one or more of the multiple TCI states associated with a non-SBFD interval type.

17. The apparatus of claim 1, wherein the information that indicates the one or more TCI states includes a downlink control information (DCI) message that indicates a TCI codepoint associated with one or more TCI states for one or more of intervals associated with a sub-band full-duplex (SBFD) interval type or intervals associated with a non-SBFD interval type.

18. The apparatus of claim 1, the at least one processor further configured to cause the apparatus to:
transmit, to the network node, information indicating a capability to support different unified TCI states in intervals associated with different duplex types.

19. A method of wireless communication performed at a user equipment (UE), comprising:
receiving, from a network node, information that configures a unified transmission configuration indication (TCI) state type for one or more duplex types;
receiving, from the network node, information that indicates one or more TCI states for communicating one or more of uplink channels, downlink channels, or reference signals in intervals associated with the one or more duplex types; and
communicating, with the network node in an interval associated with a duplex type, of the one or more duplex types, in accordance with the unified TCI state type and the one or more TCI states configured for the duplex type associated with the interval.

20. A non-transitory computer-readable medium storing a set of instructions for wireless communication, the set of instructions comprising:
one or more instructions that, when executed by one or more processors of a user equipment (UE), cause the UE to:
receive, from a network node, information that configures a unified transmission configuration indication (TCI) state type for one or more duplex types;
receive, from the network node, information that indicates one or more TCI states for communicating one or more of uplink channels, downlink channels, or reference signals in intervals associated with the one or more duplex types; and
communicate, with the network node in an interval associated with a duplex type, of the one or more duplex types, in accordance with the unified TCI state type and the one or more TCI states configured for the duplex type associated with the interval.
